(19) United States
(12) Patent Application Publication
(10) Pub. No.: US 2025/0222781 A1
(43) Pub. Date: Jul. 10, 2025

(54) CABLE-TO-RAIL APPARATUS, SYSTEMS, AND METHODS

(71) Applicant: CLIMB WORKS LLC, Gatlinburg, TN (US)

(72) Inventors: Kolby Oswald, Hendersonville, TN (US); Peter David Cochetas, Golden, CO (US)

(21) Appl. No.: 18/845,288

(22) PCT Filed: Mar. 10, 2023
(86) PCT No.: PCT/US2023/064159

§ 371 Date: Sep. 9, 2024

Related U.S. Application Data
(60) Provisional application No. 63/319,158, filed on Mar. 11, 2022.

(51) Int. Cl. B60L 13/00; B60L 5/18; B61B 7/06; B61B 12/02; B61B 12/10

(52) U.S. Cl. CPC B60L 13/006; B60L 5/18; B61B 7/06; B61B 12/02; B61B 12/10; B60L 2200/30

(57) ABSTRACT

Cable-to-rail apparatus, systems, and methods according to which the transfer of a trolley (or “rider element”) from a cable (or “line”) to a rail, via a transition structure, is facilitated at speed in a zipline or other environment.

### CROSS-REFERENCE TO RELATED APPLICATIONS

This application is a U.S. National Phase Entry of International Application No. PCT/US2023/064159, filed Mar. 10, 2023, which claims the benefit of the filing date of, and priority to, U.S. Provisional Patent Application No. 63/319,158, filed Mar. 11, 2022, the entire disclosure of which is hereby incorporated herein by reference.

### TECHNICAL FIELD

This application relates generally to cable-to-rail apparatus, systems, and methods, and, more particularly, to a cable-to-rail system adapted to facilitate transfer of a trolley (or “rider element”) from a cable (or “line”) to a rail, via a transition structure, at speed in a zipline or other environment.

### BACKGROUND

Trolley designs for use in ziplines or rail systems typically rely on gravitational forces alone for movement of the trolley, have passive and unmodulated braking systems, and only traverse linear paths.

It would be beneficial for riders and users of these systems to have a trolley system capable of spanning longer distances, turning and cornering, and smoothly transitioning between a cable and a rail. It would also be beneficial to have a trolley system capable of self-propulsion rather than relying on gravitational forces alone, as well as having a modulated braking system.

The trolley systems and apparatuses described herein attempt to address these shortcomings.

### BRIEF DESCRIPTION OF THE DRAWINGS

FIG. 1 is a perspective view illustrating a cable-to-rail system according to one or more embodiments of the present disclosure.

FIG. 2A is a perspective view illustrating an entry structure of the cable-to-rail system of FIG. 1, according to one or more embodiments of the present disclosure.

FIG. 2B is an exploded perspective view illustrating the entry structure of FIG. 2A, according to one or more embodiments of the present disclosure.

FIG. 2C is a bottom view illustrating the entry structure of FIG. 2A, according to one or more embodiments of the present disclosure.

FIG. 2D is an elevational view illustrating a half of the entry structure of FIG. 2A, according to one or more embodiments of the present disclosure.

FIG. 3A is a perspective view illustrating a transition structure and a rail connector of the cable-to-rail system of FIG. 1, according to one or more embodiments of the present disclosure.

FIG. 3B is an exploded perspective view illustrating the transition structure and the rail connector of FIG. 3A, according to one or more embodiments of the present disclosure.

FIG. 3C is a perspective view illustrating a transition tube of the transition structure of FIG. 3A, according to one or more embodiments of the present disclosure.

FIG. 3D is an enlarged perspective view illustrating the transition tube of FIG. 3C, according to one or more embodiments of the present disclosure.

FIG. 3E is an exploded perspective view illustrating the rail connector of FIG. 3A, according to one or more embodiments of the present disclosure.

FIG. 4A is a perspective view illustrating an alignment structure of the cable-to-rail system of FIG. 1, according to one or more embodiments of the present disclosure.

FIG. 4B is an elevational view illustrating an alignment bracket and a plurality of magnets of the alignment structure of FIG. 4A, according to one or more embodiments of the present disclosure.

FIG. 4C is an exploded perspective view illustrating the alignment structure of FIG. 4A, according to one or more embodiments of the present disclosure.

FIG. 4D is another exploded perspective view illustrating the alignment structure of FIG. 4A, according to one or more embodiments of the present disclosure.

FIG. 5A is a partially-exploded perspective view illustrating a rail portion of the cable-to-rail system of FIG. 1, according to one or more embodiments of the present disclosure.

FIG. 5B is an exploded perspective view illustrating a tension adjustment rail of the rail portion of FIG. 5A, according to one or more embodiments of the present disclosure.

FIG. 5C is a perspective view illustrating the rail portion of FIG. 5A with some components shown in a semitransparent state to more clearly illustrate other components, according to one or more embodiments of the present disclosure.

FIG. 6 is an exploded perspective view illustrating a crush coupler of the cable-to-rail system of FIG. 1, including a half of a barrel and a plurality of crush rings of the crush coupler, according to one or more embodiments of the present disclosure.

FIG. 7 is an exploded perspective view illustrating a trolley of the cable-to-rail system of FIG. 1, according to one or more embodiments of the present disclosure.

FIG. 8A is an exploded perspective view illustrating a cable-to-rail wheel assembly of the trolley of FIG. 7, according to one or more embodiments of the present disclosure.

FIG. 8B is an elevational view illustrating a cable-to-rail wheel of the cable-to-rail wheel assembly of FIG. 8A, according to one or more embodiments of the present disclosure.

FIG. 9 is an exploded perspective view illustrating a crush wheel assembly of the trolley of FIG. 7, according to one or more embodiments of the present disclosure.

FIG. 10 is a perspective view illustrating a spine bracket of the trolley of FIG. 7, according to one or more embodiments of the present disclosure.

FIG. 11A is a perspective view illustrating a brake assembly of the trolley of FIG. 7, according to one or more embodiments of the present disclosure.

FIG. 11B is another perspective view illustrating the brake assembly of FIG. 11A, according to one or more embodiments of the present disclosure.

FIG. 12 is an exploded perspective view illustrating a conductor assembly, a harness bracket, and the spine bracket of the trolley of FIG. 7, according to one or more embodiments of the present disclosure.

FIG. 13A is a perspective view illustrating a trolley frame of the trolley of FIG. 7, according to one or more embodiments of the present disclosure.

FIG. 13B is an elevational view illustrating the trolley frame of FIG. 13A, according to one or more embodiments of the present disclosure.

FIG. 13C is a cross-sectional view illustrating the trolley frame of FIG. 13A, according to one or more embodiments of the present disclosure.

FIG. 13D is another elevational view illustrating the trolley frame of FIG. 13A, according to one or more embodiments of the present disclosure.

FIG. 13E is another cross-sectional view illustrating the trolley frame of FIG. 13A, according to one or more embodiments of the present disclosure.

FIG. 14 is a cross-sectional view illustrating the cable-to-rail system of FIG. 1, according to one or more embodiments of the present disclosure.

FIG. 15 diagrammatically illustrates a cable-to-rail system including an electric circuit, according to one or more embodiments of the present disclosure.

### DETAILED DESCRIPTION

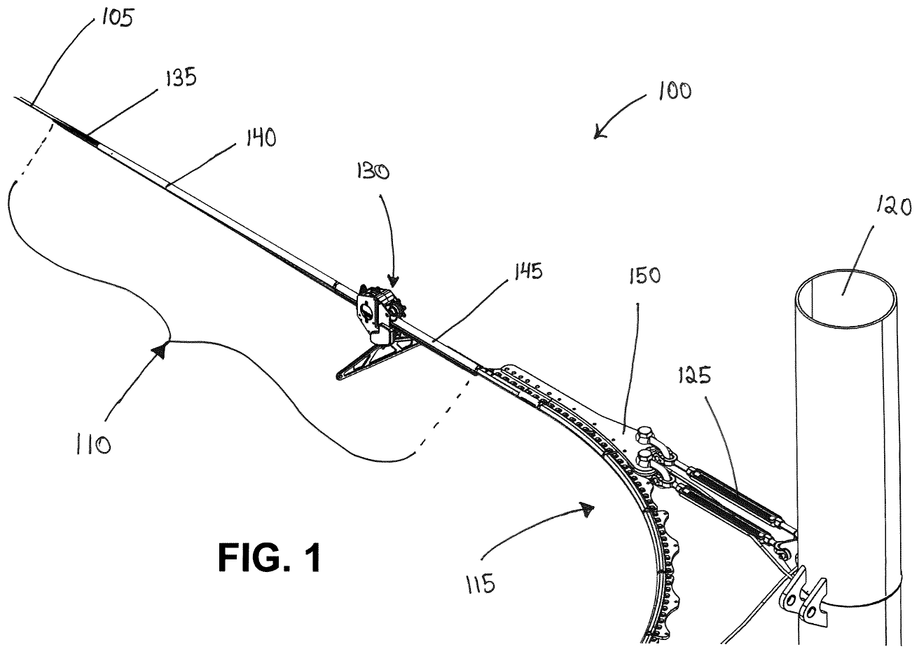

Referring to FIG. 1, a cable-to-rail system 100 is shown according to one or more embodiments. The cable-to-rail system 100 includes a cable 105 (or “line”), a transition portion 110, a rail portion 115, a tower 120 (also referred to herein as an “anchor point”, which could also be or include another mounting structure, e.g., a tree), one or more tensioners 125, and a trolley 130 (or “rider element”). In one or more embodiments, the transition portion 110, the rail portion 115, or both, may be referred to herein as a “rail assembly.” In one or more embodiments, the transition portion 110 includes an entry structure 135, a transition structure 140, and an alignment structure 145. In one or more embodiments, the rail portion 115 includes one or more tension plates 150 operably coupled to the tower 120 via the one or more tensioners 125. The one or more tensioners 125 are adapted tension the cable 105 via the rail assembly, and to enable adjustment of said tension.

The cable-to-rail system 100 is adapted to facilitate transfer of the trolley 130 from the cable 105 to the rail portion 115 via the transition portion 110 at speed in a zipline or other environment. The cable 105 under tension is extends along a linear path, and thus the trolley 130 riding along the cable 105 is restricted to this linear path. The rail portion 115, on the other hand, is able to curve, corner, or otherwise change direction. As a result, the cable-to-rail system 100 enables a continuous run of the trolley 130 through a curve or corner. In one or more embodiments, the cable-to-rail system 100 may be mirrored upon exit of a curve or corner such that cable-to-rail system 100 is adapted to facilitate transfer of the trolley 130 from the rail portion 115 back to the cable 105 (or another cable) at speed. Thus, in some embodiments, the trolley 130 runs continuously from the cable 105 to the rail portion 115 and back to the cable 105 (or the another cable) at speed.

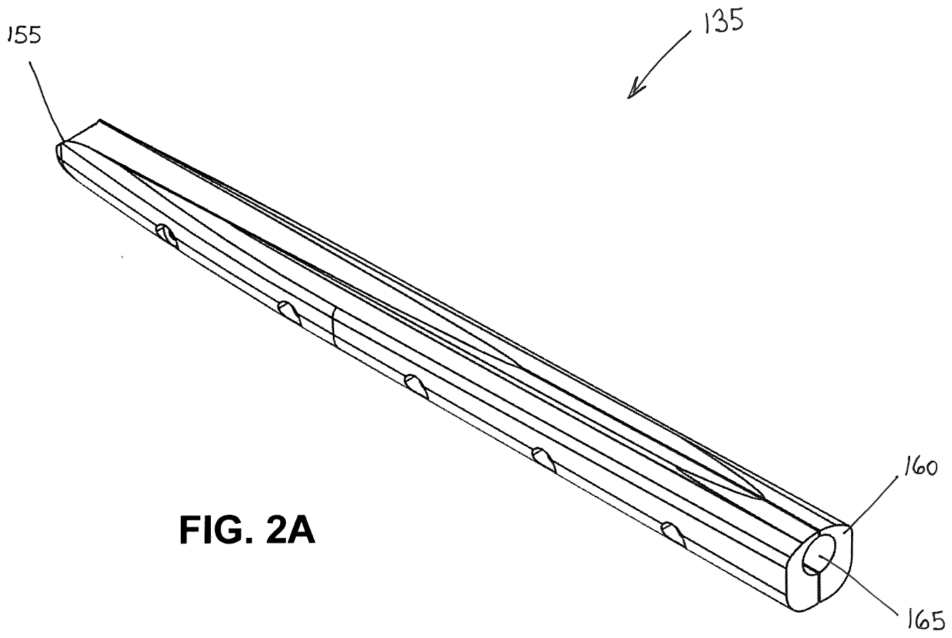

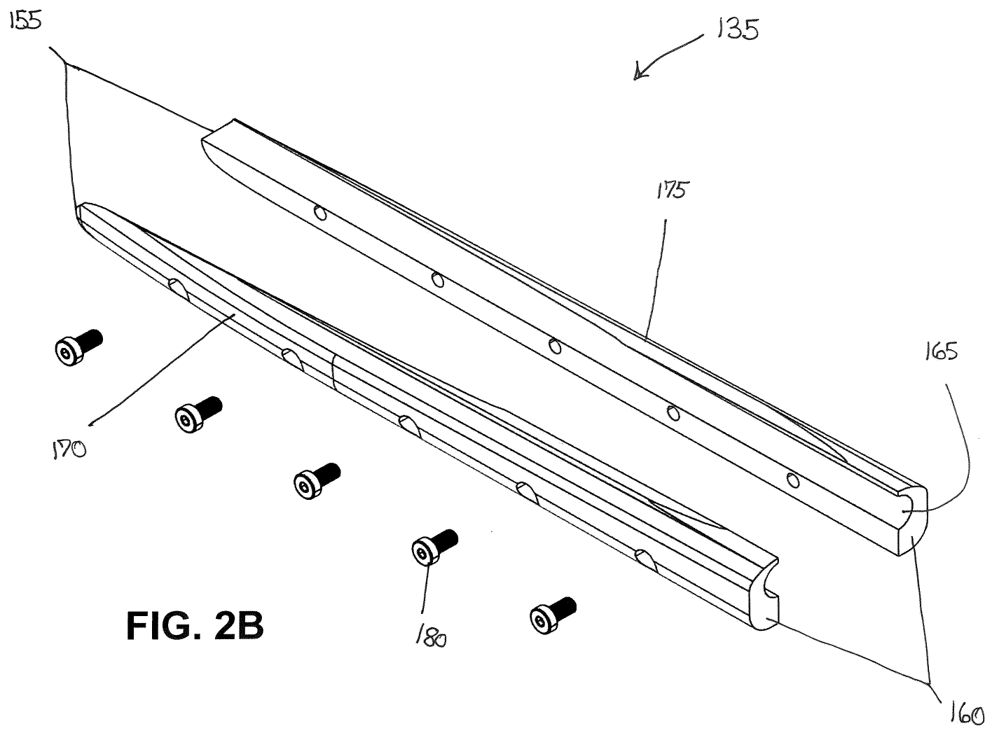

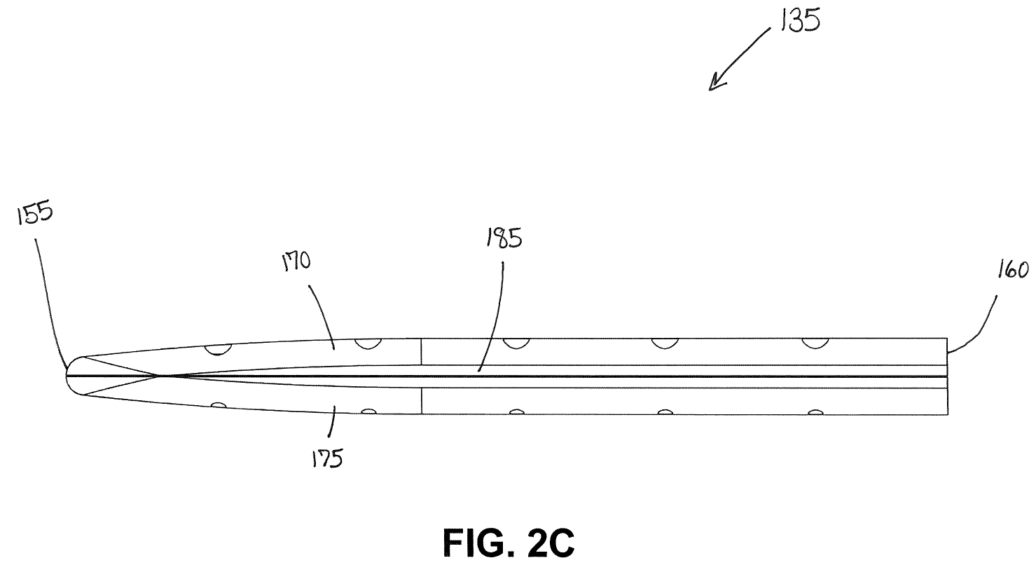

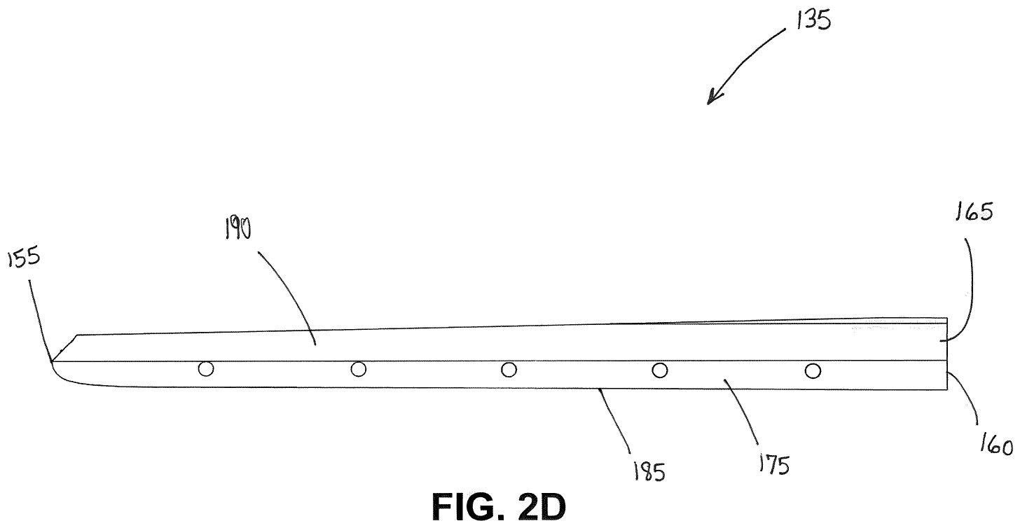

Referring to FIGS. 2A-2D, with continuing reference to FIG. 1, the entry structure 135 of the transition portion 110 is shown. The entry structure 135 has a first end 155, a second end 160, and an internal passageway 165 extending therethrough between the first end 155 and the second end 160. In some embodiments, the internal passageway 165 is configured to receive the cable 105, and thus has a diameter greater than the diameter of the cable 105. As shown in FIG. 2B, in some embodiments, the entry structure 135 is a two-piece structure such that the entry structure 135 is split into a first half 170 and a second half 175 longitudinally through the center of the internal passageway 165. In one or more embodiments, the first half 170 and the second half 175 of the entry structure 135 are coupled together by a plurality of fasteners 180. As shown in FIG. 2C, the entry structure 135 has a flat bottom surface 185 (also referred to herein as an “alignment surface”).

As shown in FIG. 2D, the entry structure 135 is tapered, or ramped, from the first end 155 to the second end 160. In one or more embodiments, the internal passageway 165 is only partially circumscribed by the entry structure 135 at the first end 155 such that an inner surface 190 of the internal passageway 165 is accessible from the top or side of the entry structure 135. At the second end 160 of the entry structure 135, the internal passageway 165 is completely circumscribed by the entry structure 135. Between the first end 155 and the second end 160 of the entry structure 135, the internal passageway 165 gradually becomes fully circumscribed and contained within the entry structure 135. In other words, the entry structure 135 has a constant angle cut beginning at a point along the longitudinal length of the external surface of the entry structure 135 between the first end 155 and the second end 160, terminating at the first end 155 of the entry structure 135, and at least partially intersecting the internal passageway 165.

In one or more embodiments, the cable 105 is received within the internal passageway 165 of the entry structure 135. In one or more embodiments, the entry structure 135 is the first point of contact for the trolley 130 as it rides along the cable 105 and approaches the transition portion 110 and the rail portion 115. The constant angle cut in the entry structure 135 provides a smooth ramping effect to smoothly transition the trolley 130 up off the cable 105 and onto the entry structure 135 towards the rail portion 115.

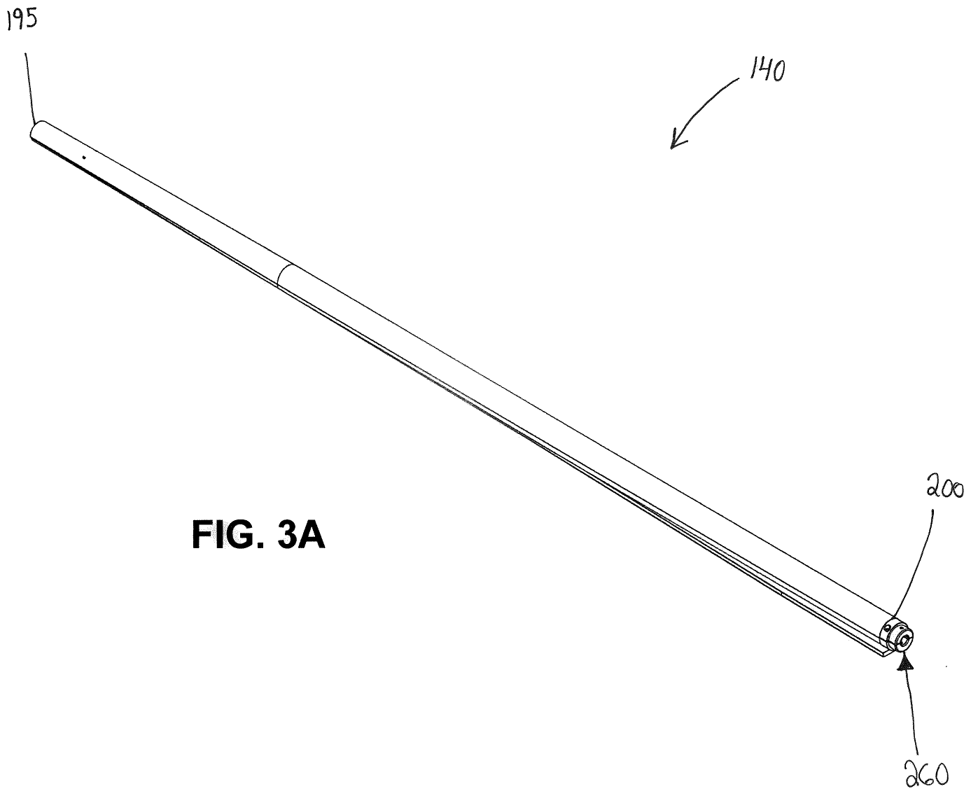

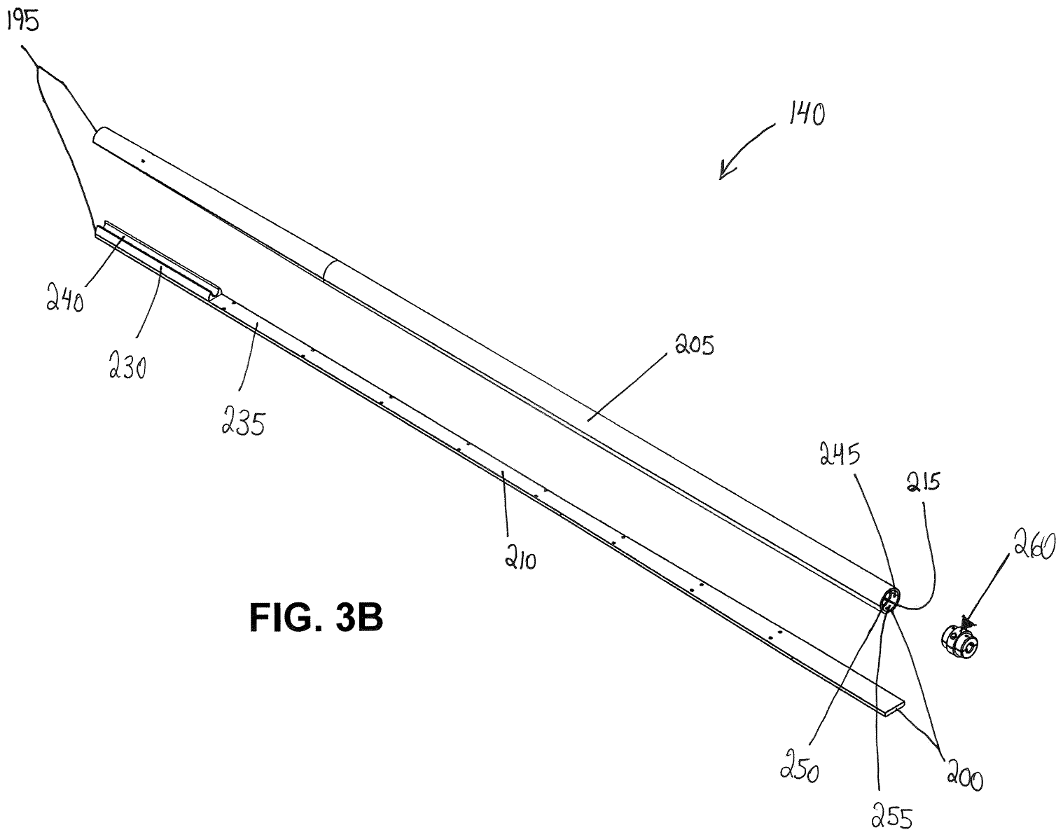

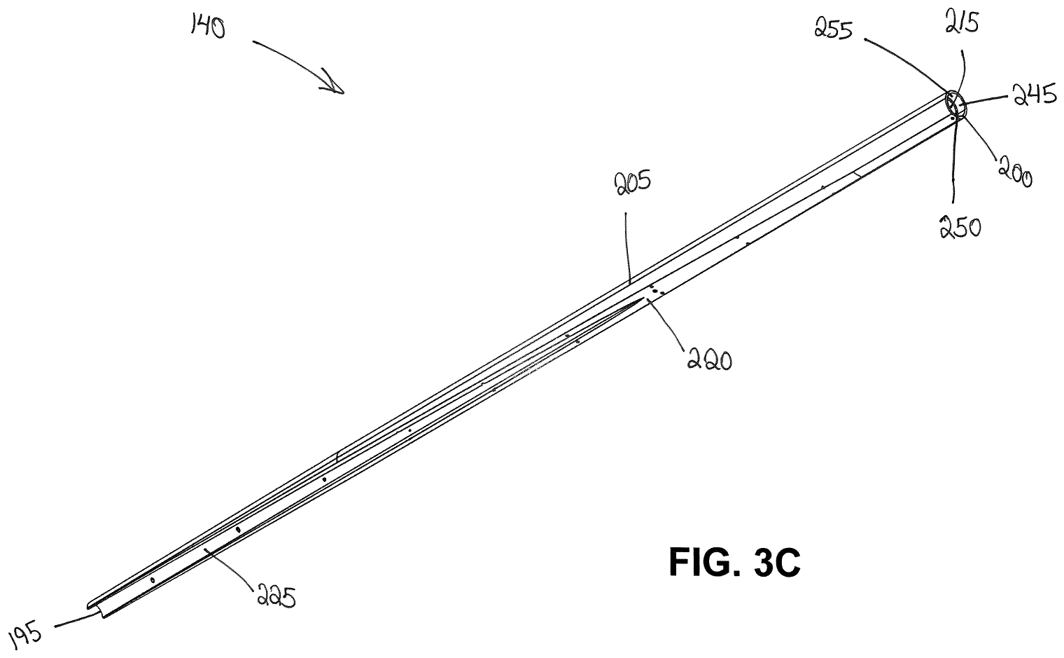

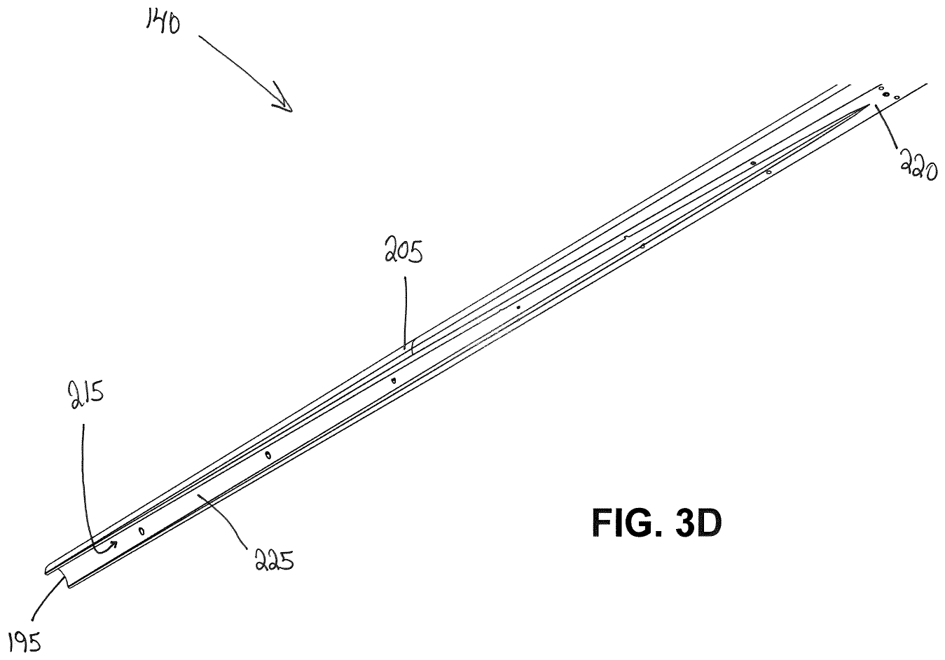

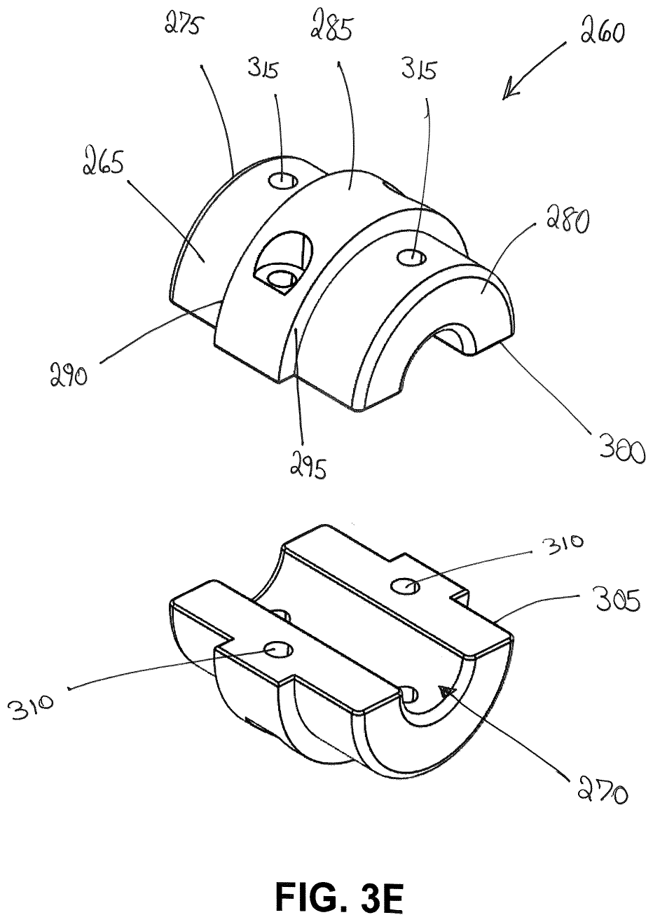

Referring to FIGS. 3A-3D, the transition structure 140 of the transition portion 110 is shown. The transition structure 140 has a first end 195 and a second end 200. In one or more embodiments, the first end 195 of the transition structure 140 and the second end 160 of the entry structure 135 are adapted to be operably connected. In one or more embodiments, the transition structure 140 and the entry structure 135 are a single uniform structure. In one or more embodiments, the entry structure 135 may float on the cable 105 independent of the transition structure 140 and may abut the transition structure 140 without attachment. The cable-to-rail system 100 is configured such that the trolley 130 is adapted to transition, or transfer, from the cable 105, to the entry structure 135, and then to the transition structure 140.

As shown in FIG. 3B, the transition structure 140 includes a transition tube 205 (e.g., a hollow rail or structural tube) and a transition plate 210 (which may be or include the “alignment surface” also referred to herein). The transition tube 205 is tapered, or ramped, between the first end 195 and the second end 200 to facilitate the smooth transition of the trolley 130 from the cable 105 to the rail portion 115. The transition tube 205 has an internal passageway 215 extending therethrough from the first end 195 to the second end 200, the internal passageway 215 being configured to receive the cable 105. As shown in FIG. 3C, at the second end 200 of the transition structure 140, the transition tube 205 completely circumscribes the internal passageway 215. As shown in FIGS. 3C and 3D, at the first end 195 of the transition structure 140, a bottom surface 220 of the transition tube 205 is cut away such that an inner surface 225 of the internal passageway 215 is accessible from the bottom or side of the transition tube 205. The cut-away on the bottom surface 220 of the transition tube 205 begins at a point along the longitudinal length of the bottom surface 220 of the transition tube 205 between the first and second ends 195,200, extends at a constant angle to the first end 195 of the transition structure 140, and at least partially intersects the internal passageway 215.

The cut-away portion of the bottom surface 220 of the transition tube 205 thus creates the tapered, or ramped, profile of the transition tube 205, in terms of its height. In one or more embodiments, the transition tube 205 is also tapered, or ramped between the first end 195 and the second end 200 in terms of the outer diameter of the transition tube 205. The outer diameter of the transition tube 205 gradually increases over at least a portion of the longitudinal length of the transition tube 205 between the first end 195 and the second end 200. This gradual tapering, or ramping, of the transition tube 205 facilitates the smooth transition of the trolley 130 from the profile of the cable 105 to the profile of the rail portion 115 of the cable-to-rail system 100.

The bottom surface 220 of the transition tube 205 is flat to facilitate attachment to the transition plate 210. The transition plate 210 has a flat rectangular shape and is configured to be mounted to the bottom surface 220 of the transition tube 205 via a plurality of fasteners. As shown in FIG. 3B, in one or more embodiments, the transition plate 210 includes a cable guide 230 extending along a top surface 235 of the transition plate 210 at the first end 195 of the transition structure 140. The cable guide 230 may extend along the entire top surface 235 of the transition plate 210, or just a portion of the top surface 235 of the transition plate 210. The cable guide 230 has a recessed, semicircular groove 240 configured to receive the cable 105. Thus, the groove 240 of the cable guide 230 has a diameter greater than the diameter of the cable 105. When the transition tube 205 and the transition plate 210 are attached, the cut-away portion of the transition tube 205 sits over top of, surrounds, and houses the cable guide 230 such that the cable guide 230 is disposed within the internal passageway 215 of the transition tube 205. Thus, the diameter of the internal passageway 215 of the transition tube 205 is greater than the diameter of the groove 240 of the cable guide 230.

In one or more embodiments, the second end 200 of the transition tube 205 has an annular recess 245. The diameter of the annular recess 245 is greater than the diameter of the internal passageway 215, thus defining a ledge 250 within the transition tube 205 where the annular recess 245 terminates and steps down to the internal passageway 215. The annular recess 245 has an interior surface 255 and the internal passageway 215 has its interior surface 225. As shown in FIGS. 3A and 3B, the annular recess 245 is configured to receive a rail connector 260. In some embodiments, the first end 195 of the transition tube 205 and the second end 160 of the entry structure 135 also include an annular recess as described above.

Referring to FIG. 3E, the rail connector 260 is shown in an enlarged and exploded configuration. In one or more embodiments, the rail connector 260 has a cylindrical body 265. An internal passageway 270 extends longitudinally through the center of the cylindrical body 265 between a first end 275 and a second end 280 of the cylindrical body 265. The internal passageway 270 is configured to receive the cable 105. In one or more embodiments, the internal passageway 270 has a diameter greater than or equal to the diameter of the cable 105. In other embodiments, the diameter of the internal passageway 270 of the rail connector 260 may be smaller than the diameter of the cable 105 to restrict axial and rotational movement of the cable 105 within the rail connector 260. In one or more embodiments, the rail connector 260 has a radially extending raised surface 285, or ring, that traverses the entire circumference of the cylindrical body 265 between the first end 275 and the second end 280 of the cylindrical body 265. The raised surface 285 has a diameter greater than the diameter of the cylindrical body 265, thus defining a first ledge 290 and a second ledge 295 on opposing sides of the raised surface 285 where the raised surface 285 terminates and steps down to the cylindrical body 265.

In one or more embodiments, the rail connector 260 is a two-piece structure, split in half longitudinally through the center of the internal passageway 270 into a first half 300 and a second half 305. In one or more embodiments, the raised surface 285 has a through hole 310 on either side of the internal passageway 270 and extending through both the first half 300 and the second half 305 of the rail connector 260. The through holes 310 are configured to receive fasteners to attach the first half 300 and the second half 305 of the rail connector 260 together around the cable 105. In one or more embodiments, the cylindrical body 265 has a through hole 315 on either side of the raised surface 285, extending through both halves 300,305 of the rail connector 260, and extending through the center of the internal passageway 270. In one or more embodiments, the through holes 315 in the cylindrical body 265 are configured to receive fasteners adapted to secure the relative axial positions and rotational orientations of the rail connector 260 and the cable 105 with respect to each other. In one or more embodiments, the through holes 315 in the cylindrical body 265 are configured to receive fasteners adapted to operably connect two portions and/or structures of the cable-to-rail system 100 together. For example, in one or more embodiments, the rail connector(s) 260 may connect the transition portion 110 to the rail portion 115, the transition structure 140 to the alignment structure 145, and/or separate sections of the rail portion 115.

As shown in FIG. 3A, the first end of the rail connector 260 is connected to the second end 200 of the transition tube 205. The diameter of the annular recess 245 in the second end 200 of the transition tube 205 is larger than the diameter of the cylindrical body 265 of the rail connector 260. Thus, the first end 275 of the cylindrical body 265 is inserted into the annular recess 245 of the transition tube 205. When fully connected, the ledge 250 defined by the annular recess 245 of the transition tube 205 abuts the first ledge 290 defined by the raised surface 285 of the rail connector 260.

In one or more embodiments, the rail connector 260 is made of nylon. In one or more embodiments, there may be a plurality of rail connector 260s in the cable-to-rail system 100. The rail connector 260 provides torsional alignment of the various portions and structures of the cable-to-rail system 100 (e.g., the entry structure 135, the transition structure 140, the alignment structure 145, and/or the rail portion 115) on the cable 105. It prevents twisting or other undesirable movement of those portions and structures on the cable 105. The rail connector 260 also allows for some deflection or flex between the connected portions and structures to reduce stresses in the cable-to-rail system 100.

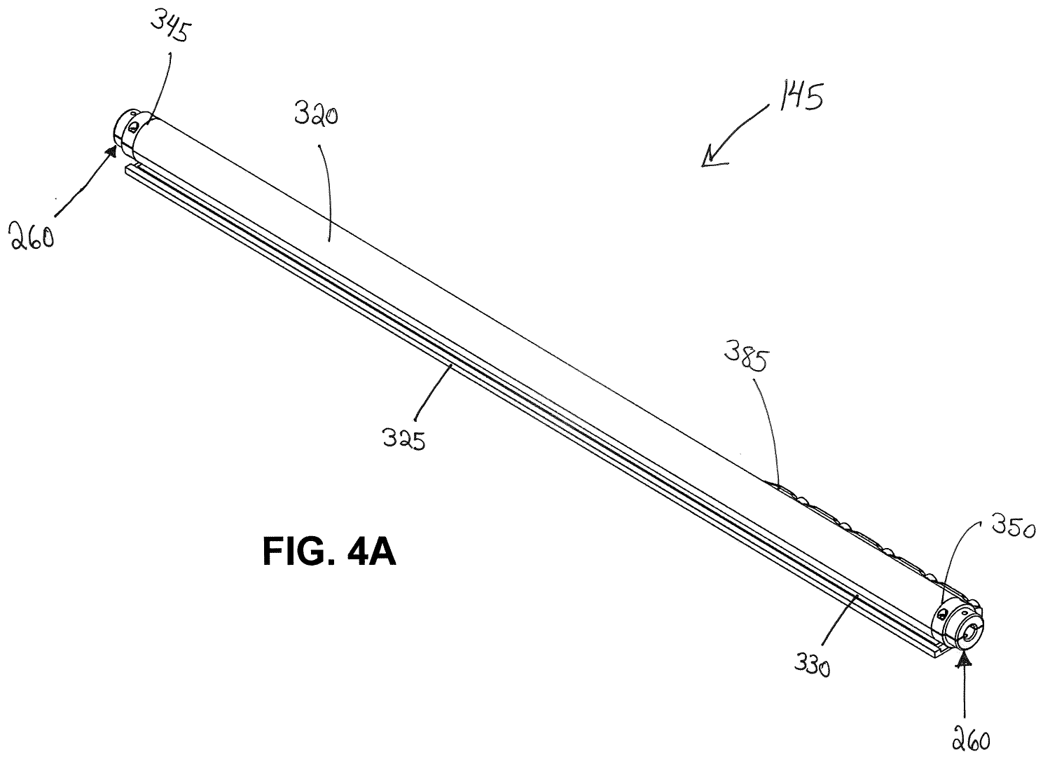

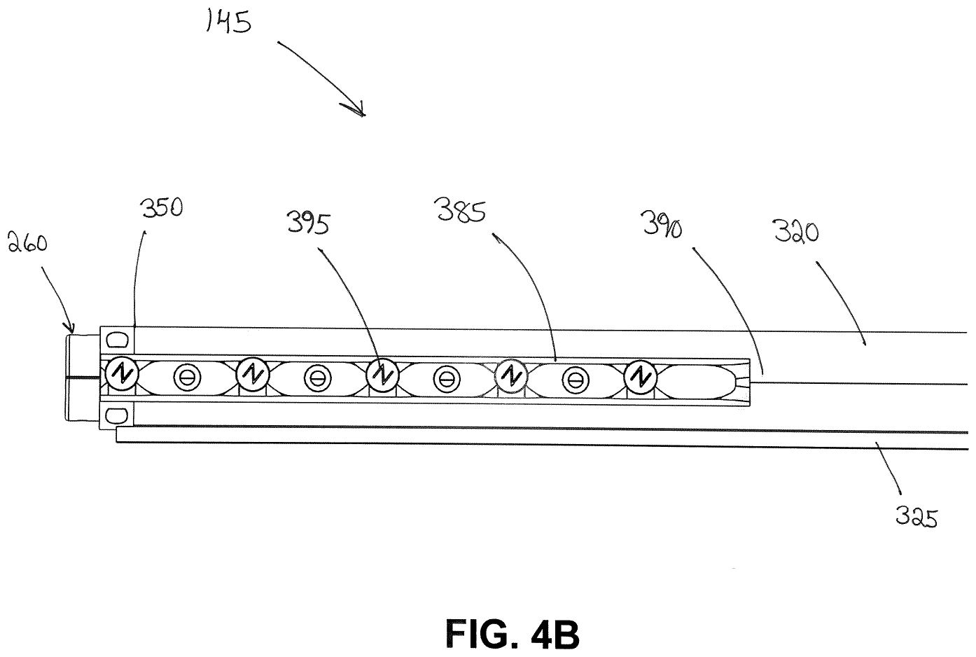

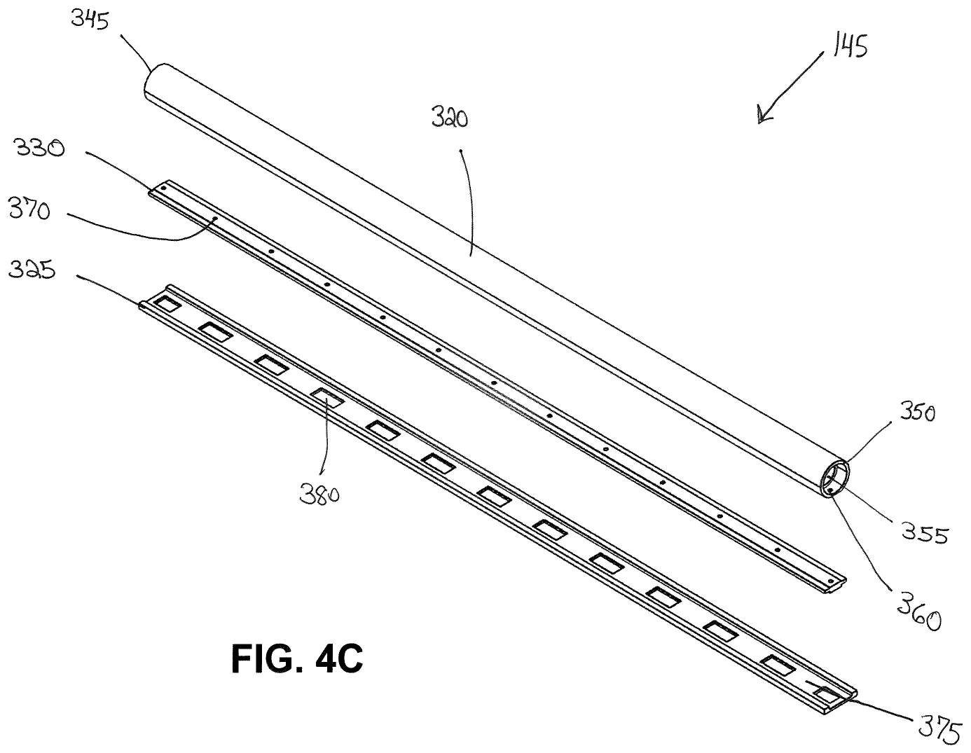

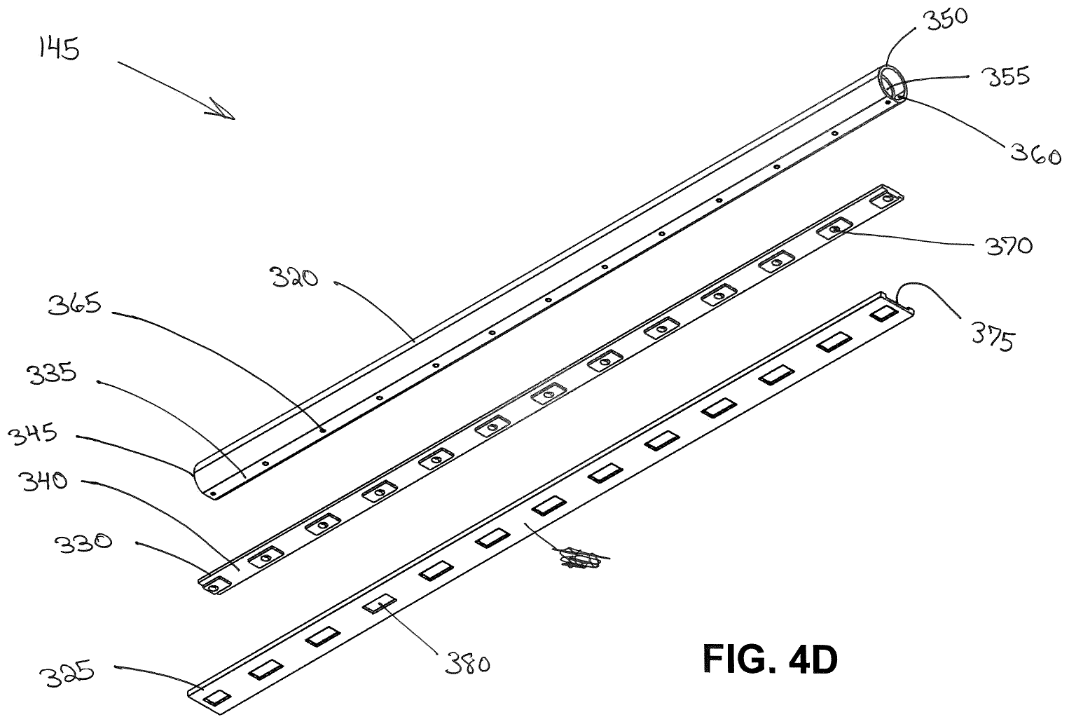

Referring to FIGS. 4A-4D, the alignment structure 145 of the cable-to-rail system 100 is shown. The alignment structure 145 includes an alignment rail 320, a conductor plate 325 (also referred to herein as a “second electrical conductor”, which may be or include the “alignment surface” referred to herein), and an insulator 330 (or “electrical insulator”). In one or more embodiments, when assembled, the insulator 330 is attached to a bottom surface 335 of the alignment rail 320, and the conductor plate 325 is attached to a bottom surface 340 of the insulator 330. In one or more embodiments, the alignment rail 320 is entirely spaced apart and electrically insulated from the conductor plate 325 by the insulator 330, for reasons that will be described in more detail below. The alignment rail 320 (e.g., a hollow rail or structural tube) has a first end 345, a second end 350, and an internal passageway 355 extending therethrough along a longitudinal axis from the first end 345 to the second end 350. In one or more embodiments, the alignment rail 320 is made of aluminum. The internal passageway 355 is configured to receive the cable 105 and thus has a diameter greater than or equal to the diameter of the cable 105. As shown in FIGS. 4C and 4D, at each end 345,350 of the alignment rail 320 is an annular recess 360 substantial similar to the annular recess 245 described above with respect to the transition tube 205. As shown in FIG. 4A, the first and second ends 345,350 of the alignment rail 320 are each configured to receive one of the plurality of rail connectors 260 to facilitate connection of the alignment rail 320 with the transition tube 205 and/or the rail portion 115.

As shown in FIG. 4D, the bottom surface 335 of the alignment rail 320 is flat to facilitate attachment to the insulator 330 and conductor plate 325. The bottom surface 335 also includes a plurality of longitudinally space through holes 365 configured to receive a plurality of fasteners to facilitate attachment to the insulator 330 and conductor plate 325. In one or more embodiments, the insulator 330 is flat and rectangular in shape, made of nylon or another material that is not electrically conductive, and has a plurality of longitudinally spaced through holes 370 corresponding with the through holes 365 of the alignment rail 320. In one or more embodiments, the conductor plate 325 is flat and rectangular in shape and has a width that is larger than the width of the insulator 330. In one or more embodiments, the conductor plate 325 may have a recessed surface 375 with a width and depth corresponding to the width and depth of the insulator 330 such that the insulator 330 may be received within the conductor plate 325 to result in a flush attachment with respect to the top surfaces of the insulator 330 and the conductor plate 325. In other embodiments, the top surface of the insulator 330 may be raised above the top surface of the conductor plate 325 when assembled to ensure there is no contact between the conductor plate 325 and the alignment rail 320. The conductor plate 325 has a plurality of attachment gaps 380, as shown in FIGS. 4C and 4D, configured to permit attachment of the alignment rail 320, insulator 330, and conductor plate 325 while ensuring the alignment rail 320 is entirely spaced apart and electrically insulated from the conductor plate 325.

In one or more embodiments, as shown in FIGS. 4A and 4B, the alignment rail 320 has an alignment bracket 385 attached to the alignment rail 320 at the second end 350 of the alignment rail 320. In one or more embodiments, the alignment bracket 385 is attached to a side surface 390 of the alignment rail 320 so as to not block or interrupt the trolley 130 as it rides along the alignment rail 320. The alignment bracket 385 extends along the longitudinal length of the alignment rail 320 between the second end 350 and the first end 345. The alignment bracket 385 extends a predetermined distance that is optimized for the particular application, as will be explained in more detail below.

In one or more embodiments, the alignment bracket 385 includes a plurality of magnets 395 evenly spaced along the alignment bracket 385. In one or more embodiments, the magnets 395 may be rare earth magnets. The magnets 395 facilitate the alignment of portions of the trolley 130 as it approaches the rail portion 115 of the cable-to-rail system 100, as will be explained in more detail below.

In one or more embodiments, the trolley 130 rides along the cable 105 until it reaches the transition portion 110. The entry structure 135, transition structure 140, and alignment structure 145 of the transition portion 110 smoothly prepare the trolley 130 to engage and ride along the rail portion 115 of the cable-to-rail system 100. The cable 105 of the cable-to-rail system 100 extends through the internal passageways 165,215,355,270 of each of the entry structure 135, the transition structure 140, the alignment structure 145, and the plurality of rail connectors 260 connecting the various portions and structures of the cable-to-rail system 100. In one or more embodiments, the entry structure 135 is the first point of contact for the trolley 130 as the trolley 130 rides along the cable 105 and approaches the transition portion 110. The ramped surface of the entry structure 135 smoothly guides the trolley 130 up off the cable 105. After riding along the entry structure 135, the trolley 130 is transferred to the transition structure 140. The tapered, or ramped, profile of the transition tube 205 smoothly transitions the trolley 130 up to the profile of the rail portion 115 of the cable-to-rail system 100. After riding along the transition structure 140, the trolley 130 is transferred to the alignment structure 145. The alignment structure 145, via the alignment bracket 385 and conductor plate 325, facilitates alignment of the trolley 130 before it reaches the rail portion 115. The conductor plate 325 also facilitates braking of the trolley 130 to help reduce the speed of the trolley 130 as necessary, depending on the application, before the trolley 130 reaches the rail portion 115. The braking aspect will be discussed in more detail below. After riding along the transition structure 140, the trolley 130 is transferred to the rail portion 115.

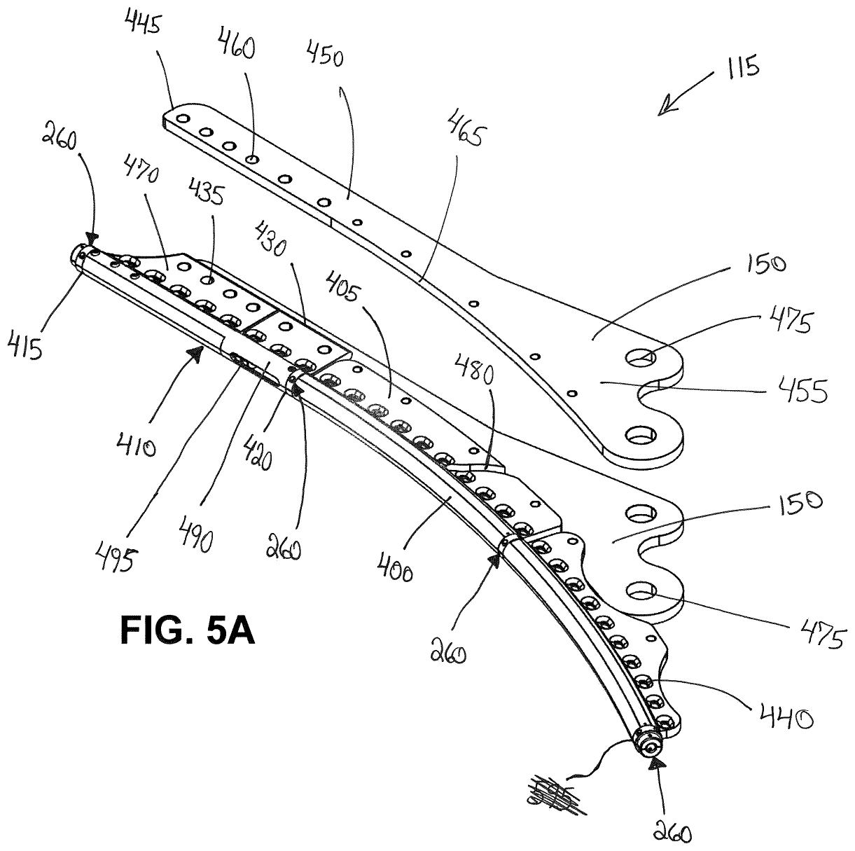

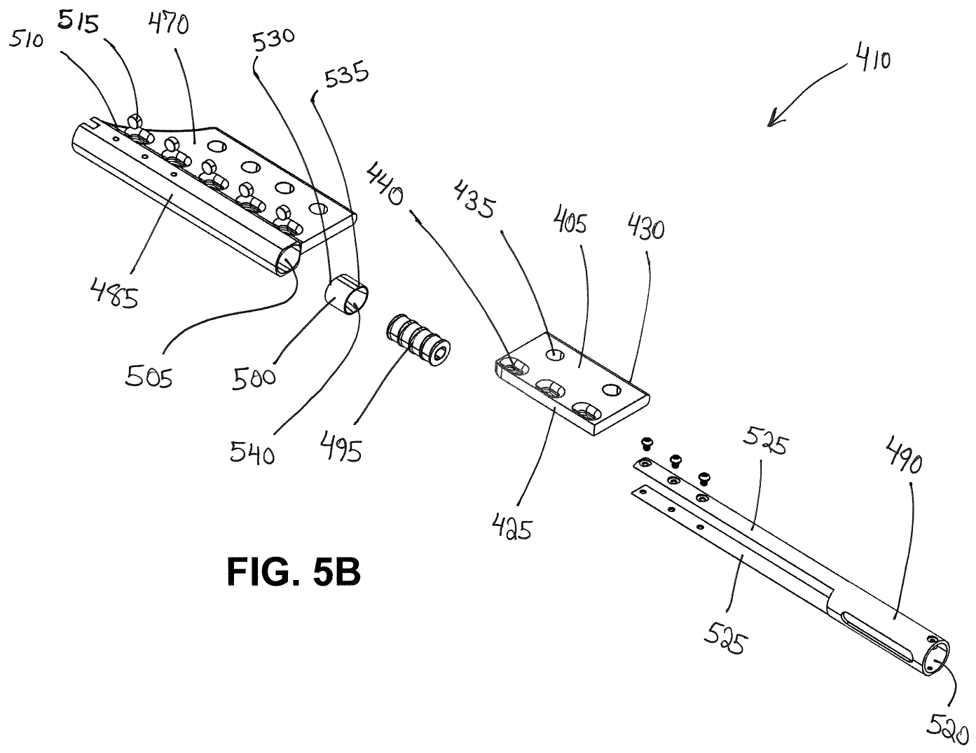

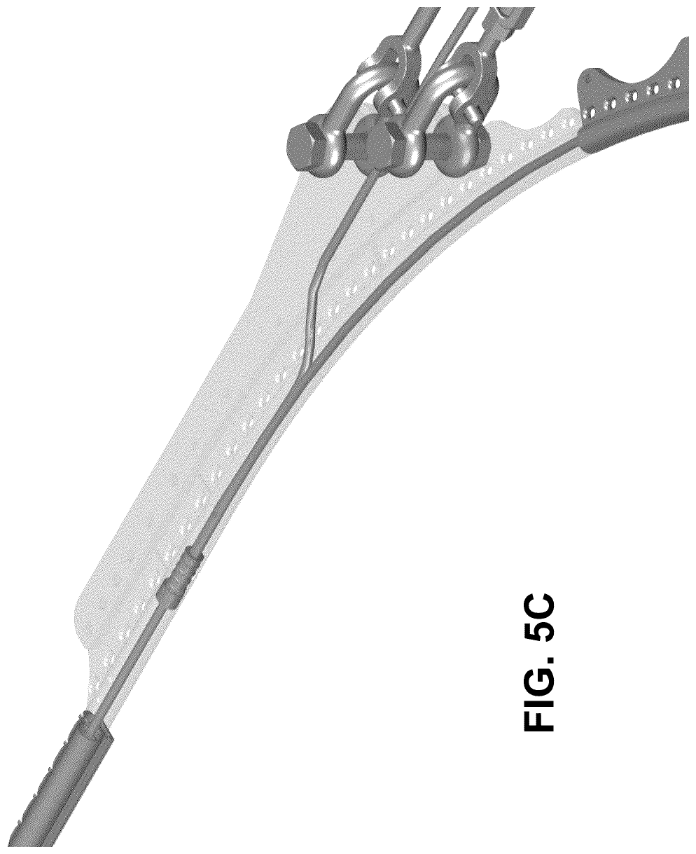

Referring to FIGS. 5A-5C, the rail portion 115 of the cable-to-rail system 100 is shown. FIG. 5A shows a partially exploded view of the rail portion 115, according to one or more embodiments. The rail portion 115 includes a rail 400 (e.g., a hollow rail or structural tube), a rail bracket 405, a tension adjustment rail 410 (e.g., a hollow rail or structural tube), and a pair of tension plates 150. In one or more embodiments, these elements of the rail portion 115 may be curved to facilitate turning or cornering of the trolley 130 along its path. In one or more embodiments, the rail 400 is made of aluminum. In one or more embodiments, the rail 400 and rail bracket 405 are sectioned into a plurality of rails 400 and rail brackets 405 to allow for flex and deflection within the rail portion 115 to reduce stresses in the cable-to-rail system 100. There may be as many rail 400 and rail bracket 405 sections as desired depending on the application.

In one or more embodiments, a first end 415 of the tension adjustment rail 410 is connected to the alignment structure 145 and a second end 420 of the tension adjustment rail 410 is connected to the rail 400. These connections are made via the rail connectors 260. In one or more embodiments, all connections between the plurality of rail sections 400 are made via the rail connectors 260.

In one or more embodiments, the rail brackets 405 have an inner edge 425 and an outer edge 430. The inner edges 425 of the rail brackets 405 are attached to the rails 400 and to the tension adjustment rail 410 such that as the trolley 130 rides along the tension adjustment rail 410 and along the rail 400, the rail brackets 405 are able to pass through the trolley 130, as will be discussed in more detail below. In one or more embodiments, this attachment can be made via fasteners, welding, or another suitable means. In other embodiments, the rail brackets 405 may be integrally formed with the rails 400 and with the tension adjustment rail 410. Along the outer edges 430 of the rail brackets 405 are a plurality of mounting holes 435 configured to receive a plurality of fasteners. Between the plurality of mounting holes 435 and the inner edges 425 of the rail brackets 405 are a plurality of equally spaced and uniformly shaped cog slots 440 that help align, drive, and/or brake the trolley 130, as will be discussed in more detail below.

In one or more embodiments, the each of the tension plates 150 has a curved, key-shaped or Y-shaped profile having a narrow first end 445, a long and narrow body 450, and a wider second end 455. The tension plates 150 have a plurality of mounting holes 460 spaced along a curved inner edge 465. The mounting holes 460 correspond with the mounting holes 435 of the rail bracket 405 and are configured to receive a plurality of fasteners. In one or more embodiments, the tension plates 150 are attached to one or more of the rail brackets 405 via the corresponding mounting holes 435,460 and the plurality of fasteners. One of the tension plates 150 is attached to a top surface 470 of the one or more rail brackets 405, and the other tension plate 150 is attached to a bottom surface of the one or more brackets 405. In one or more embodiments, the wider second ends 455 of the tension plates 150 have one or more tensioner mount holes 475. The tensioner mount holes 475 are configured to be attached to the one or more tensioners 125, which attach the rail portion 115 to the tower 120.

In one or more embodiments, the tension plates 150 are attached to the rail brackets 405 that are attached to the tension adjustment rail 410. As will be discussed in more detail below, the tension adjustment rail 410 transfers the tension in the cable 105 to the tension plates 150. Thus, in this configuration, the tension in the cable 105 can be adjusted through the tension plates 150 via adjustment of the tensioners 125.

In one or more embodiments, one of the rail 400 and rail bracket 405 sections includes an exit slot 480. The exit slot 480 extends between two of the cog slots 440 in the rail bracket 405. The exit slot 480 allows the cable 105 to exit the rail 400 and rail bracket 405 and extend externally of the trolley 130.

Referring to FIG. 5B, an exploded view of the tension adjustment rail 410 is shown, according to one or more embodiments. The tension adjustment rail 410 includes a tension transfer rail 485, a swage housing 490, a swage 495, and a swage sleeve 500.

In one or more embodiments, the tension transfer rail 485 has an internal passageway 505 extending therethrough, which is configured to receive the cable 105. The tension transfer rail 485 is attached to one or more of the rail brackets 405 as described above. In one or more embodiments, the tension transfer rail 485 includes a magnet bracket 510 and a plurality of magnets 515 identical or substantially similar to those described above with respect to the alignment rail 320. The magnets 515 may be attached to the side of the tension transfer rail 485 via the magnet bracket 510 such that the magnets 515 are evenly spaced with each magnet 515 aligning with one of the cog slots 440, for reasons that will be explained in more detail below.

In one or more embodiments, the swage housing 490 (e.g., a hollow rail or structural tube) has an internal passageway 520 extending therethrough, which is configured to receive the cable 105. The swage housing 490 has two parallel attachment flanges 525 extending from opposing surfaces. In one or more embodiments, the swage housing 490 is configured to slide over, receive, and contain the swage 495 and swage sleeve 500 within the internal passageway 520. The two flanges 525 are configured to extend over and attach to opposing surfaces of the tension transfer rail 485 to connect the swage housing 490 to the tension transfer rail 485.

In one or more embodiments, the swage 495 is a split cable clamp configured to be connected around the cable 105 via fasteners. In other embodiments, the swage 495 is a single uniform clamp configured to slide onto the cable 105 from one end of the cable 105. In one or more embodiments, the swage 495 is configured to be crushed, clamped, or otherwise compressed around the cable 105 to prevent axial movement of the cable 105 relative to the swage 495.

In one or more embodiments, the swage sleeve 500 has a first end 530, a second end 535, and an internal passageway 540 extending therethrough. The size of the internal passageway 540 is tapered from the second end 535 to the first end 530. In one or more embodiments, the swage sleeve 500 has a frustoconical shape such that the diameter of the internal passageway 540 at the first end 530 is smaller than the diameter of the internal passageway 540 at the second end 535. In one or more embodiments, the swage sleeve 500 is sized such that it abuts the tension transfer rail 485 and remains entirely located within the internal passageway 520 of the swage housing 490. In other embodiments, the swage sleeve 500 is configured to be press fit into the internal passageway 540 of the tension transfer rail 485. In still other embodiments, the swage sleeve 500 may be configured to extend within both the internal passageway 540 of the tension transfer rail 485 and the internal passageway 520 of the swage housing 490.

In one or more embodiments, the second end 535 of the swage sleeve 500 receives the swage 495. The swage sleeve 500 and swage 495 are sized such that the swage 495 cannot entirely pass through the swage sleeve 500. As the swage 495 is pulled further into the swage sleeve 500 by the tension in the cable 105, the swage sleeve 500 compresses the swage 495 further to ensure that the cable 105 and swage 495 do not slip relative to each other. The swage sleeve 500 and swage 495 together are sized such that they cannot pass entirely through the internal passageway 505 of the tension transfer rail 485.

The assembly of the tension adjustment rail 410 is configured to allow for direct adjustment, monitoring, and/or maintenance of the swage 495 and of the tension in the cable 105.

In one or more embodiments, the rail portion 115 also includes additional sections of the insulator 330 and the conductor plate 325 as described above with respect to the alignment structure 145 of the transition portion 110. In one or more embodiments, the bottom surfaces of the rail 400 and of the tension adjustment rail 410 are flat and have a plurality of through holes that facilitate attachment of the insulator 330 and of the conductor plate 325. The insulator 330 and conductor plate 325 are attached to the bottom surfaces of the rail 400 and the tension adjustment rail 410 in the same manner and orientation as described above with respect to the alignment structure 145. In one or more embodiments, the insulator 330 and the conductor plate 325 extend along the entire rail portion 115.

FIG. 5C is an illustration of the rail portion 115 wherein the tension plates 150, the rail brackets 405, the tension adjustment rail 410, and the rail 400 have been made transparent for illustrative purposes only. As shown, in one or more embodiments, a second cable 545 is joined with the cable 105 at the swage 495. In one or more embodiments, the second cable 545 is spliced with the cable 105 within the swage 495. Because the swage 495 transfers the tension in the cable 105 to the tension plate 150 via the tension adjustment rail 410, the portions of the cable 105 and the second cable 545 that extend beyond the swage 495 are un-tensioned.

As discussed above with respect to FIG. 5A, and with continuing reference to FIG. 1, in one or more embodiments, the cable 105 may exit the rail 400 via an exit in one of the sections of the rail 400 and via the exit slot 480 in one of the sections of the rail bracket 405. Upon exit from the rail portion 115, the cable 105 extends to the tower 120. In one or more embodiments, the cable 105 is connected to, and terminates at, the tower 120. In one or more embodiments, the cable 105 extends around the tower 120, via a plurality of guides, brackets, and/or fasteners, and extends back to the rail portion 115 of the cable-to-rail system 100.

One advantage of the cable 105 exiting the rail portion 115 and extending to the tower 120 is that it can serve as a visual safety check as to the status of the cable-to-rail system 100. As discussed, the portion of the cable 105 that extends past the swage 495 is un-tensioned because the swage 495 transfers the tension in the cable 105 to the tension plates 150 via the tension adjustment rail 410. Thus, the portion of the cable 105 extending to the tower 120 should visually appear slack and un-tensioned. If, however, the swage 495 were to fail, there would be tension in the portion of the cable 105 extending to the tower 120. Upon quick visual inspection of the portion of the cable 105 extending to the tower 120, it can be determined whether the cable 105 is slack and therefore the swage 495 is functioning properly, or whether the cable 105 is pulled taut and therefore indicating failure of the swage 495 or possibly another element of the tension adjustment rail 410.

The second cable 545, after being spliced with the cable 105 in the swage 495, extends un-tensioned through the rest of the rail 400. The second cable 545 extends through the plurality of sections of the rail 400 and through the plurality of rail connectors 260 connecting the plurality of rail sections 400. The second cable 545 facilitates alignment of the plurality of rail sections 400 and may also serve as a safety if the rail 400 were to fail as the second cable 545 can be used to support the rail sections 400 and the trolley 130.

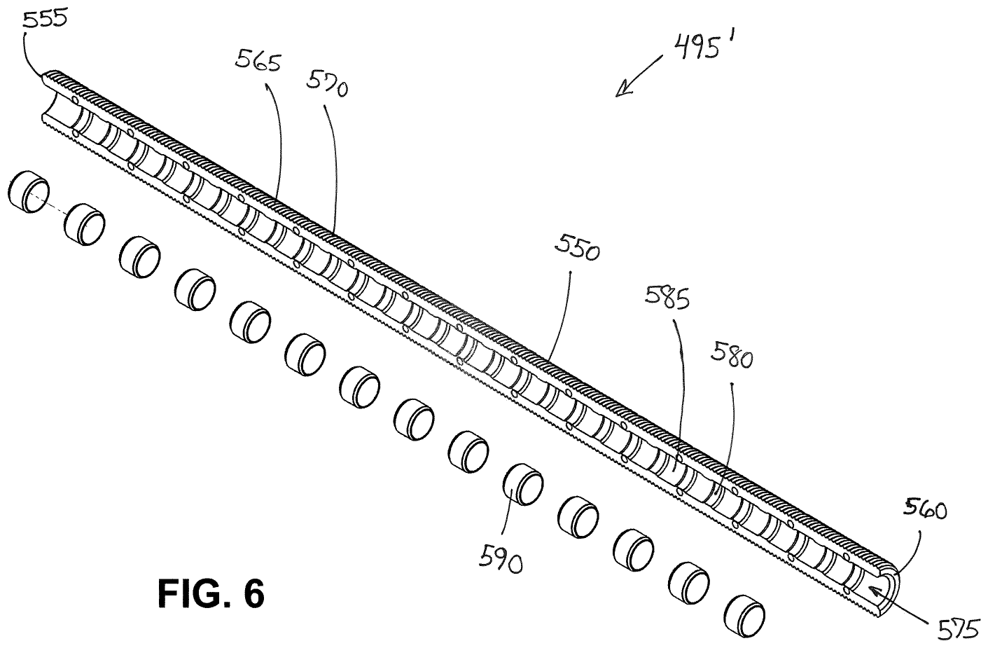

Referring to FIG. 6, an exploded view of a portion of a crush coupler 495′ is shown. In one or more embodiments, the crush coupler 495′ may be used instead of the swage 495 and the swage sleeve 500. The crush coupler 495′ (e.g., a hollow tube or pipe) has a barrel 550 having a first end 555 and a second end 560. An external surface 565 of the barrel 550 has external threads 570 extending around the circumference of the barrel 550 between the first end 555 and the second end 560. The barrel 550 has an internal passageway 575 extending therethrough between the first end 555 and the second end 560, which is configured to receive the cable 105. In one or more embodiments, the crush coupler 495′ may be split in half and configured to be attached around the cable(s) 105,545 with a plurality of fasteners.

Within the internal passageway 575 are a plurality of recessed grooves 580 extending circumferentially into an internal surface 585 of the barrel 550. In one or more embodiments, the grooves 580 are configured to receive a plurality of crush rings 590, which may be made of copper in some embodiments. The crush rings 590 are configured to be crushed around the cable(s) 105,545 when the two halves of the crush coupler 495′ are fastened together, or by an external force applied to the external surface 565 of the barrel 550. In one or more embodiments, the grooves 580 are configured to receive an epoxy. The crush rings 590 and/or epoxy are configured to prevent axial movement of the cable(s) 105,545 and the crush coupler 495′ relative to each other.

As described above with reference to FIG. 1, the rail portion 115 can be mirrored at its first end 415 and its second end (not shown) in order to transfer the trolley 130 back to the cable 105. In one or more embodiments, the elements shown in FIGS. 5A-5C are located at either end of the rail portion 115. As such, in one or more embodiments, there is a tension adjustment rail 410 (e.g., including a swage 495 or crush coupler 495′), a pair of tension plates 150, and an exit slot 480 formed in a section of the rail bracket 405 at either end of the rail portion 115.

The trolley 130 transfers from the cable 105 to the rail 400 at the first end 415 as described above. After a turn or corner has been made, for example, it may be desirable to transfer the trolley 130 back to the cable 105 at the second end of the rail portion 115. In one or more embodiments, the portion of the cable 105 that exited the rail 400 and rail bracket 405 near the first end 415 and extended around the tower 120 is then routed back to a second exit slot in the rail bracket 405 near the second end of the rail portion 115. The cable 105 is received in the second exit slot and received back into the rail 400. At the second end of the rail portion 115 is a second tension adjustment rail, which is mounted to a second pair of tension plates operably connected to the tower 120. Within the second tension adjustment rail, the cable 105 is spliced with a second end of the second cable 545 in a second swage or crush coupler. The tension in the cable-to-rail system 100 is transferred back to the portion of the cable 105 extending past the second swage or crush coupler and exiting the rail portion 115 in the same manner as at the first end 415 of the rail portion 115.

At the second end of the rail portion 115, there is a second transition portion identical to the transition portion 110 located before the first end 415 of the rail portion 115. The second transition portion is configured to smoothly transition the trolley 130 back to the cable 105, just as the transition portion 110 before the first end 415 smoothly transitioned the trolley 130 from the cable 105 to the rail portion 115.

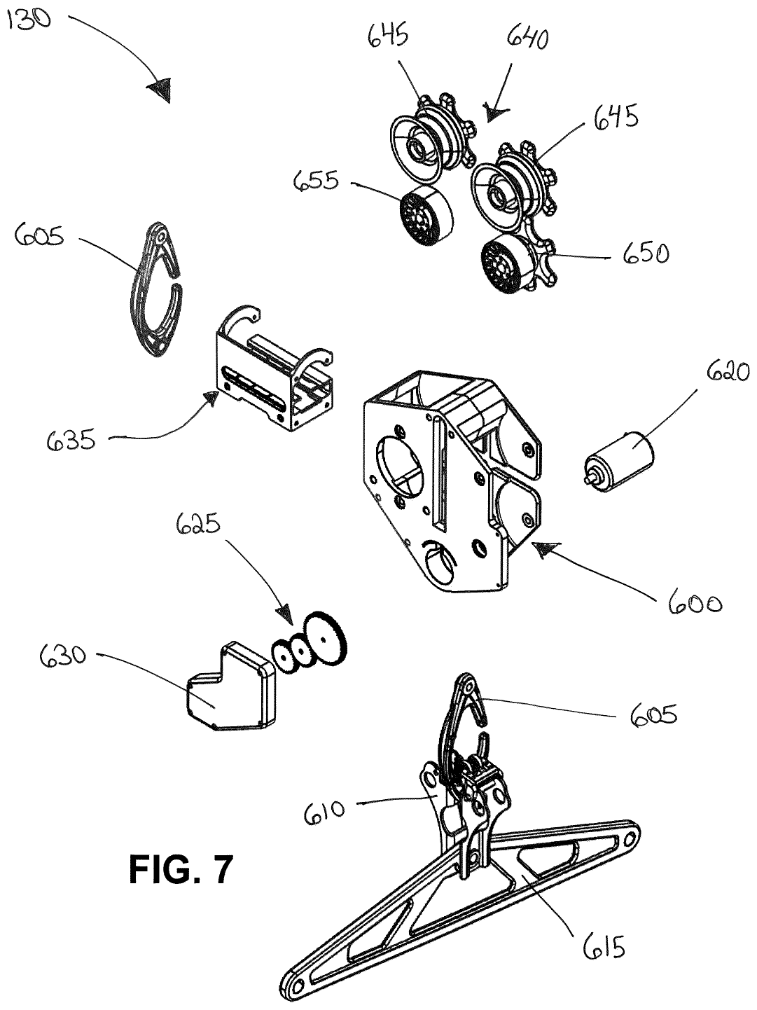

Referring to FIG. 7, an exploded view of the trolley 130 is shown. In one or more embodiments, the trolley 130 includes a trolley frame 600 (or “frame”), a pair of spine brackets 605, a harness bracket 610, a harness bar 615, a motor 620, a plurality of gears 625, a gear housing 630, a braking assembly 635, and a plurality of wheels 640. In the embodiment shown in FIG. 7, the plurality of wheels 640 includes two cable-to-rail wheel assemblies 645, a crush wheel assembly 650, and a crush wheel 655 (or “alignment wheel”).

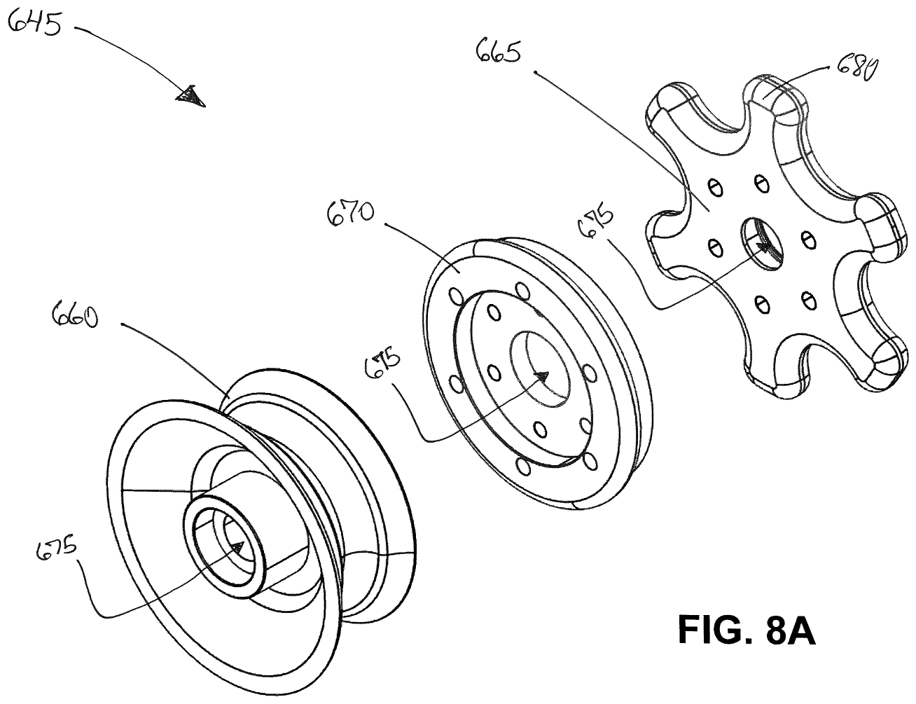

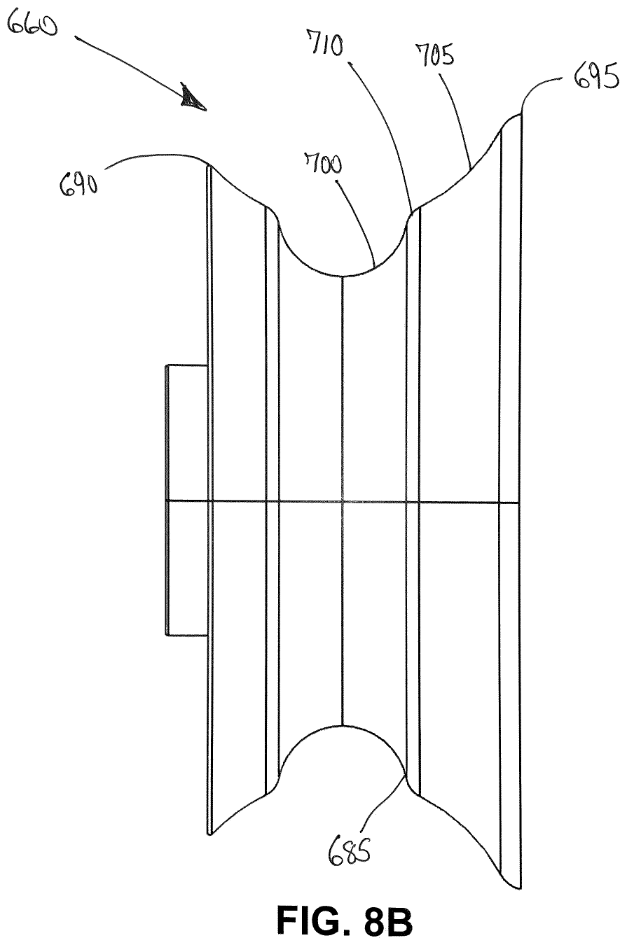

Referring to FIG. 8A, one of the cable-to-rail wheel assemblies 645 is shown. The cable-to-rail wheel assembly 645 includes a cable-to-rail wheel 660 (or “carriage wheel”), a drive wheel 665 (e.g., a “cog wheel”), and a wheel mount 670 (e.g., a “cog mount”). The cog wheel 665 is attached to the cable-to-rail wheel 660 via the cog mount 670 and a plurality of fasteners. In one or more embodiments, the cog mount 670 is made of nylon and is adapted to absorb forces applied to the cable-to-rail wheel assembly 645 and reduce wear of the cable-to-rail wheel 660 and of the cog wheel 665. The cable-to-rail wheel assembly 645 is adapted to receive an axle (e.g., a bolt or dowel pin) through an internal passageway 675 such that the axle defines an axis of rotation of the cable-to-rail wheel assembly 645.

In one or more embodiments, the cog wheel 665 includes a plurality of teeth 680 (e.g., “cog teeth”) integrally formed with and radially extending from an outer edge of the cog wheel 665. The plurality of cog teeth 680 are evenly distributed around the outer circumference of the cog wheel 665. In the embodiment shown in FIG. 8A, the cog wheel 665 has six cog teeth 680 evenly distributed around its outer circumference. In one or more embodiments, the plurality of cog teeth 680 are magnetic.

FIG. 8B is another illustration of the cable-to-rail wheel 660 of the cable-to-rail wheel assembly 645. The cable-to-rail wheel 660 is symmetrical about its axis of rotation. The cable-to-rail wheel 660 has a contact surface 685 located between a first edge 690 and a second edge 695. In one or more embodiments, the diameter of the first edge 690 may be less than the diameter of the second edge 695. In one or more embodiments, the contact surface 865 is adapted to contact the cable 105 and/or the rail 400 of the cable-to-rail system 100 and enables the trolley 130 to ride along the cable 105 and/or the rail 400. In one or more embodiments, the contact surface 685 of the cable-to-rail wheel 660 has a first profile 700 and a second profile 705. In one or more embodiments, the first profile 700 is located toward the middle of the contact surface 685 and the second profile 705 is located on either side of the first profile 700 between the first profile 700 and the first edge 690 of the cable-to-rail wheel 660 and between the first profile 700 and the second edge 695 of the cable-to-rail wheel 660. In one or more embodiments, the first profile 700 is radially closer to the axis of rotation of the cable-to-rail wheel 660 than the second profile 705.

In one or more embodiments, the first profile 700 is adapted to contact and ride along the cable 105 and thus has a size, shape, and/or contour similar to that of the cable 105. The first profile 700 may be semicircular and have a diameter greater than or equal to the diameter of the cable 105. In one or more embodiments, the second profile 705 is adapted to contact and ride along the rail 400 and thus has a size, shape, and/or contour similar to that of the rail 400. The second profile 705 is also adapted to contact and ride along the entry structure 135, the transition tube 205, the alignment rail 320, and the tension adjustment rail 410 as the trolley 130 transitions from the cable 105 to the rail 400.

In one or more embodiments, there may be a transition profile 710 between the first and second profiles 700,705. The transition profile 710 may facilitate a smooth transition from the first profile 700 to the second profile 705 so that there is not an abrupt jump from the first profile 700 to the second profile 705, or vice-versa, as the trolley 130 transfers from the cable 105 to the rail 400, or from the rail 400 to the cable 105. The transition profile 710 may help smoothly guide the cable-to-rail wheel 660 off the cable 105 and along the transition portion 110.

The edges 690,695 of the cable-to-rail wheel 660 and the contours of the profiles 700,705 also help facilitate alignment of the trolley 130 as it rides along the cable 105, rail 400, or transition portion 110 of the cable-to-rail system 100.

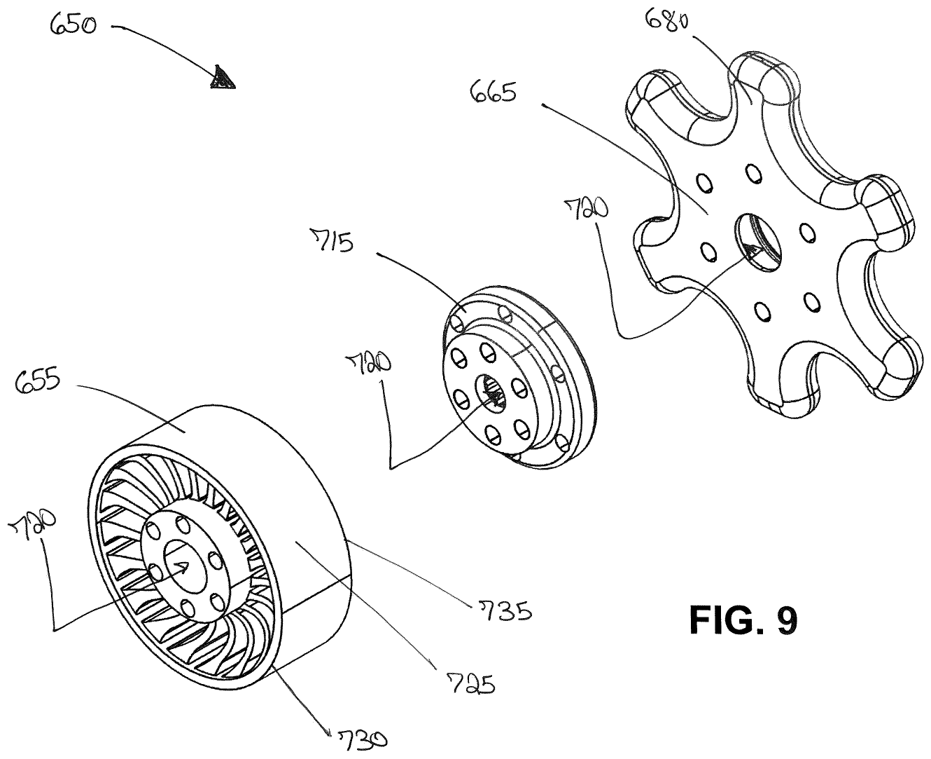

Referring to FIG. 9, an exploded view of the crush wheel assembly 650 is shown. The crush wheel assembly 650 includes another cog wheel 665, a cog adapter 715, and another crush wheel 655. The cog wheel 665 is attached to the crush wheel 655 via the cog adapter 715 and a plurality of fasteners. In one or more embodiments, the cog adapter 715 is identical to the cog mount 670 of the cable-to-rail wheel assembly 645. In one or more embodiments, the cog adapter 715 is a bearing. In one or more embodiments, at least a portion of the cog adapter 715 is made of nylon and is adapted to absorb forces applied to the crush wheel assembly 650 and reduce wear of the crush wheel 655 and of the cog wheel 665. The crush wheel assembly 650 is adapted to receive an axle (e.g., a bolt or dowel pin) through an internal passageway 720 such that the axle defines an axis of rotation of the crush wheel assembly 650.

The crush wheel 655 is symmetrical about its axis of rotation. The crush wheel 655 has a contact surface 725 between a first edge 730 and a second edge 735. The contact surface 725 is flat and uniform. The contact surface 725 is configured to contact the transition plate 210 and the conductor plate 325 to guide and align the trolley 130 as it rides along the transition portion 110 and the rail portion 115 of the cable-to-rail system 100.

In one or more embodiments, the crush wheel 655 also provides a braking effect with respect to the trolley 130. In one or more embodiments, the crush wheel 655 may me made of a material that is deformable, compressible, and/or deflectable such that when the crush wheel 655 comes into contact with the transition plate 210 and the conductor plate 325, the crush wheel 655 is able absorb energy from the impact and slow the trolley 130 down.

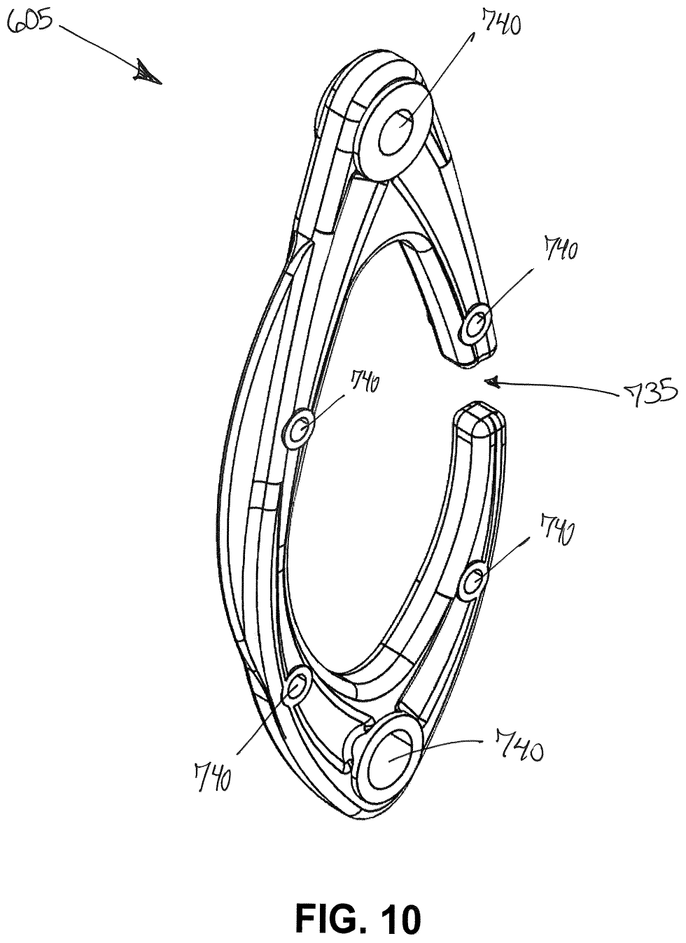

Referring to FIG. 10, the spine bracket 605 is shown. The spine bracket 605 has a C-shape with an opening 735, or channel, on one side that is configured to allow the rail brackets 405 to pass through the opening 735 as the trolley 130 rides along the rail portion 115. When the cable 105 passes through the exit slot 480 in one of the rail brackets 405, the cable 105 is also able to pass through the opening 735 in the spine bracket 605. The spine bracket 605 has a plurality of mounting holes 740 adapted to receive fasteners to mount the spine bracket 605 to the trolley frame 600 and to the harness bracket 610, and to attach the braking assembly 635 to the spine bracket 605 on the trolley 130. The spine bracket 605 is configured to provide additional structural support to the trolley frame 600, facilitate alignment of the trolley 130, and provide mounting points for attachments to the trolley 130 as desired for the particular application.

In one or more embodiments, one of the spine brackets 605 may be used as an anchor to dampen the swing of the trolley 130 or the harness bar 615.

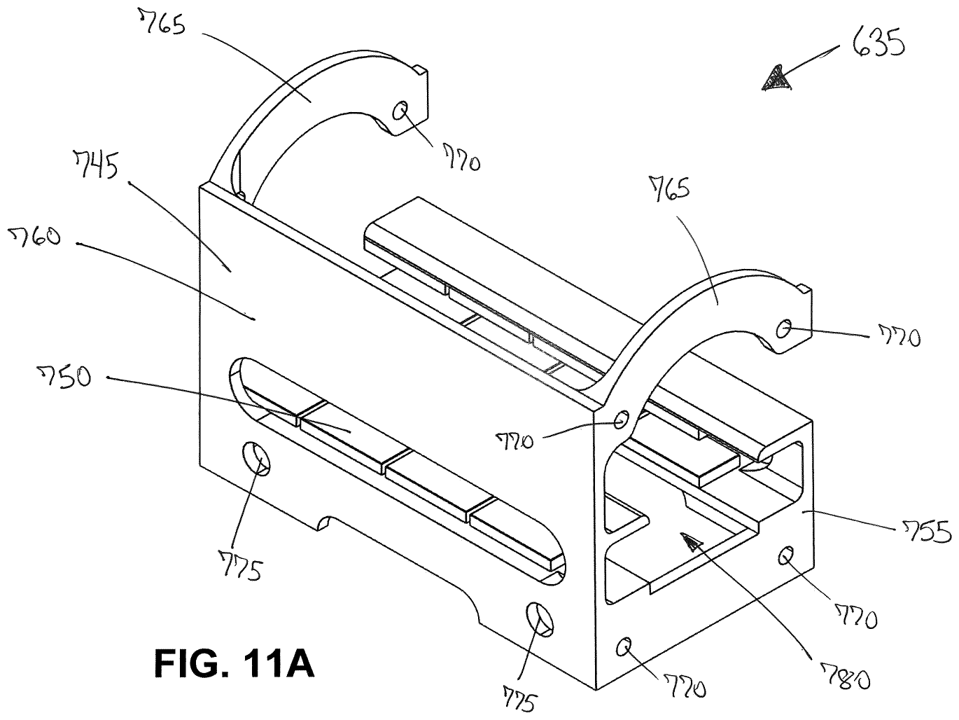

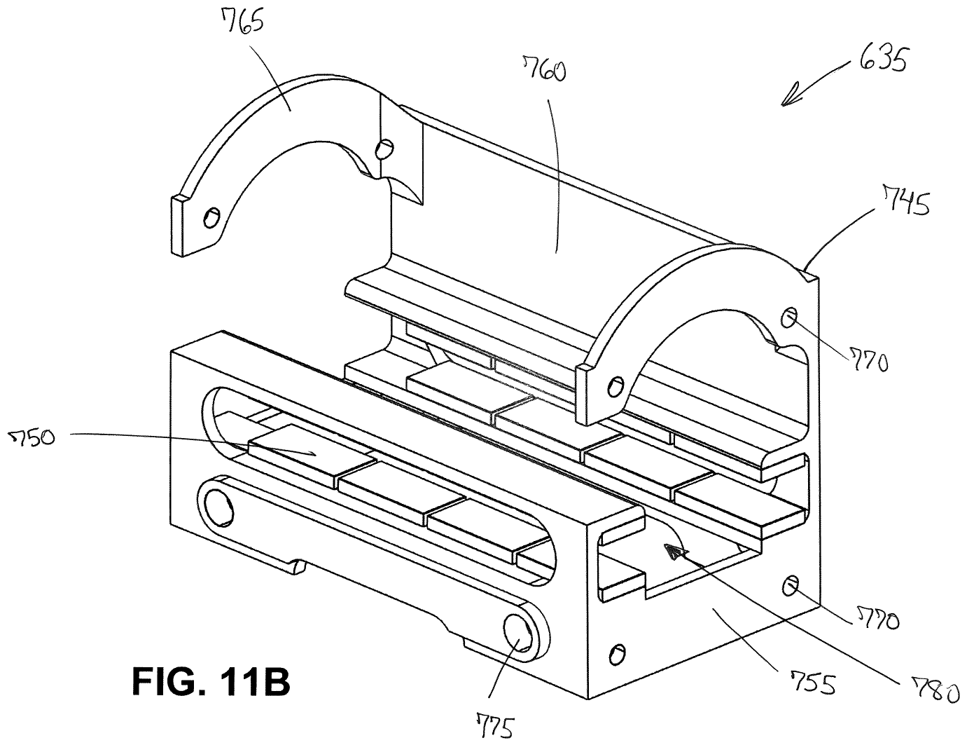

Referring to FIGS. 11A and 11B, the braking assembly 635 is shown. The braking assembly 635 includes a braking bracket 745 and a plurality of magnets 750. The braking bracket 745 has a partially formed rectangular base structure 755, a side wall 760 extending up from the rectangular base 755 on one side, and a pair of arched mounting flanges 765 extending from the side wall 760 across, and vertically spaced from, the rectangular base 755. The rectangular base 755 and the pair of flanges 765 have a plurality of mounting holes 770 corresponding with, and configured to be attached to via the plurality of fasteners, some of the mounting holes 740 of the spine bracket 605. Additional mounting holes 775 located through the side of a lower portion of the rectangular base 755 correspond with mounting holes 775′ in the trolley frame 600 and are configured to receive fasteners to attach the braking bracket 745 directly to the trolley frame 600.

The rectangular base 755 of the braking bracket 745 has a rectangular channel 780 extending therethrough. The rectangular channel 780 is adapted to receive and allow the transition plate 210 and the conductor plate 325 pass through it. The plurality of magnets 750 are attached along top and bottom interior surfaces of the rectangular channel 780 along at least a portion of the length of the rectangular channel 780. In one or more embodiments, this is a linear magnet array. In one or more embodiments, the magnets 750 are electromagnets. In one or more embodiments, the magnets 750 are rare earth magnets. In one or more embodiments, the rare earth magnets are aligned in north-south polarity. The plurality of magnets 750 are attached to the channel surfaces such that at least portions of the transition plate 210 and the conductor plate 325 pass directly between the magnets 750. The magnets 750 attached along the top surface of the channel 780 pass directly over-top at least a portion of the plates 210,325, and the magnets 750 attached along the bottom surface of the channel 780 pass directly beneath at least a portion of the plates 210,325.

In one or more embodiments, the plurality of magnets 750 (e.g., the linear magnet array) of the braking assembly 635 provides eddy current braking to facilitate braking of the trolley 130. Eddy current braking provides contactless braking using magnets formed into a magnetic circuit, a conductor, and relative motion between the two. The plurality of magnets 750 attached to the braking bracket 745 form the magnetic circuit. The conductor plate 325 is an electrically conductive plate that carries an electrical current, as will be described in more detail below. The relative motion between the plurality of magnets 750 of the braking assembly 635 and the conductor plate 325 as the trolley 130 rides along the alignment rail 320 and the rail portion 115 facilitates creation of the eddy currents. Eddy current braking is beneficial because it is frictionless and thus does not result in wear on components, noise, or contamination.

Modulation of the eddy current braking effect can be accomplished by varying any one or more of the following elements: magnet strength; magnetic circuit; direction or angle of magnetic flux; relative speed of conductor and magnets; interaction between the conductor and magnets; mechanical properties of the conductor; material properties of the conductor; and temperature of the system or components.

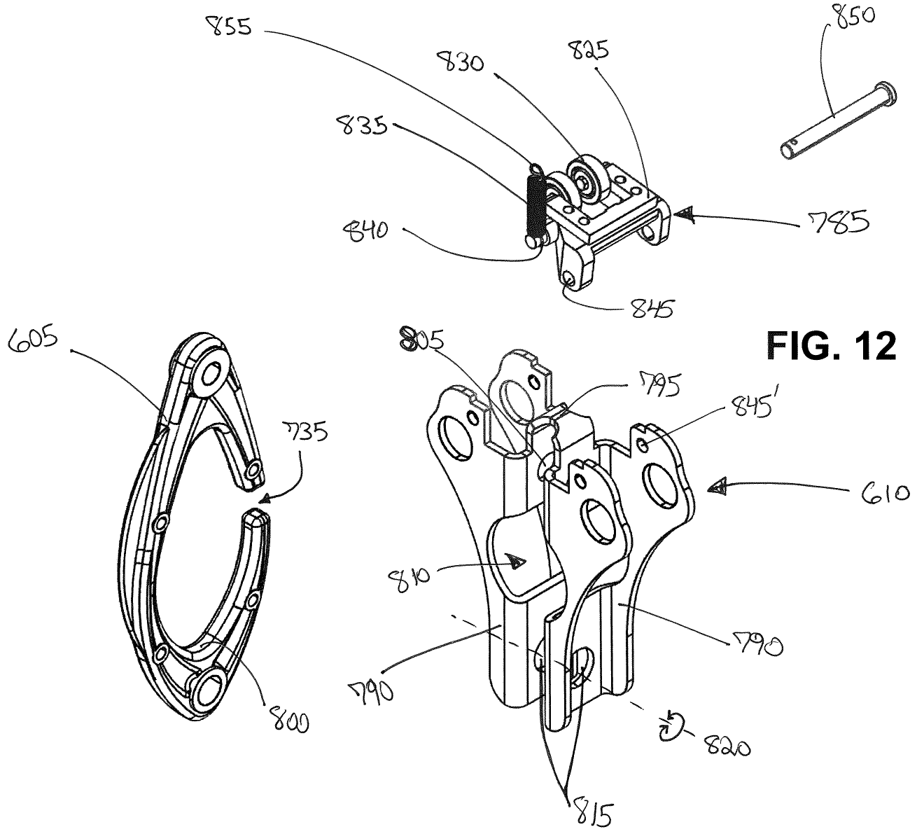

Referring to FIG. 12, an exploded view of the spine bracket 605, the harness bracket 610, and a conductor assembly 785 is shown. The harness bracket 610 is generally U-shaped, comprising two plates 790 that are connected at the top 795 such that the two plates 790 are spaced apart. The harness bracket 610 is able to be slotted through the opening 735 in the spine bracket 605 to link the spine bracket 605 and the harness bracket 610 together. The connection at the top 795 of the harness bracket 610 is adapted to rest on an interior edge 800 of the spine bracket 605 at the base of the spine bracket 605. A mounting hole 805 in the harness bracket 610 corresponding with the mounting hole 740 at the base of the spine bracket 605 is adapted to receive a fastener to attach the harness bracket 610 to the spine bracket 605. The physical contact between the connection at the top 795 of the harness bracket 610 and the interior edge 800 of the spine bracket 605 reduces the forces applied to the fastener connecting the spine bracket 605 and the harness bracket 610. That contact also provides additional safety as the spine bracket 605 and harness bracket 610 would remain linked together if the fastener connecting them failed. The two plates 790 also each have a gap 810 and together are configured to receive and support the motor 620.

The harness bracket 610 also includes corresponding mounting holes 815 at the bottom of both of the plates 790 of the harness bracket 610. As shown in FIG. 7, these mounting holes 815 are configured to receive a fastener to attach the harness bar 615 to the harness bracket 610. The harness bar 615 is pivotably attached to the harness bar 615 such that the harness bar 615 is able to roll about an axis 820 that is coaxial with an axis extending through the centers of the mounting holes of the harness bracket 610 via which the harness bar 615 is attached. Generally, this axis 820 about which the harness bar 615 can roll is parallel to the direction of travel of the trolley 130. The harness bar 615 is only able to roll about the axis 820. It is not able to pitch or yaw. In other words, the harness bar 615 can swing side to side relative to the direction of travel of the trolley 130, but it cannot swing forward and back or rotate relative to the direction of travel of the trolley 130.

In one or more embodiments, the harness bar 615 is configured to support one or more riders attached thereto. In one or more embodiments, the harness bar 615 may be configured to support cargo, equipment, tools, or any other object desired to be moved by the cable-to-rail system 100.

The conductor assembly 785 includes a mounting bracket 825, one or more conductor bearings 830 (or “first electrical conductor”), and a spring 835. The conductor bearing(s) 830 are electrically conductive and are adapted to be attached to the mounting bracket 825. A first end 840 of the spring is adapted to be attached to the mounting bracket 825. Mounting holes 845 on the mounting bracket 825 correspond with mounting holes 845′ on the harness bracket 610. The mounting bracket 825 and the harness bracket 610 are adapted to the pivotably attached via a pin 850 or bolt through their corresponding mounting holes 845,845′. The second end 855 of the spring 835 is adapted to be attached to the trolley frame 600. During operation, the conductor bearings 830 are adapted to make contact with the bottom surface of the conductor plate 325 of the alignment rail 320 and of the rail portion 115. The spring 835 biases the conductor bearings 830 to a state of constant contact with the conductor plate 325 despite any bouncing or turbulence within the cable-to-rail system 100.

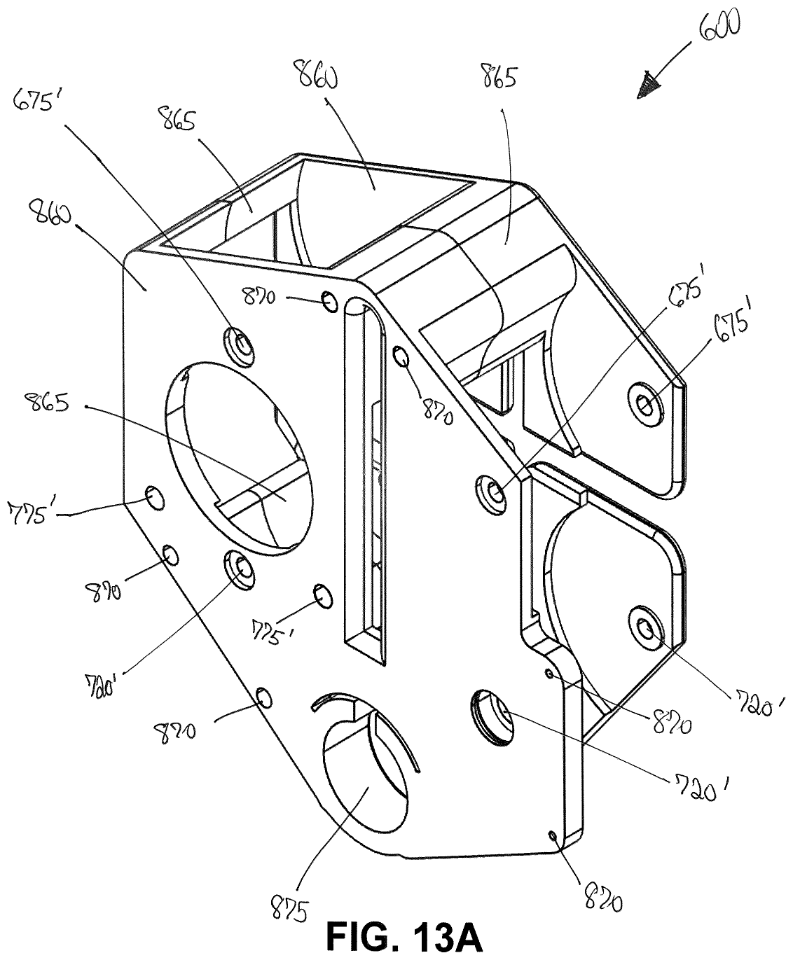

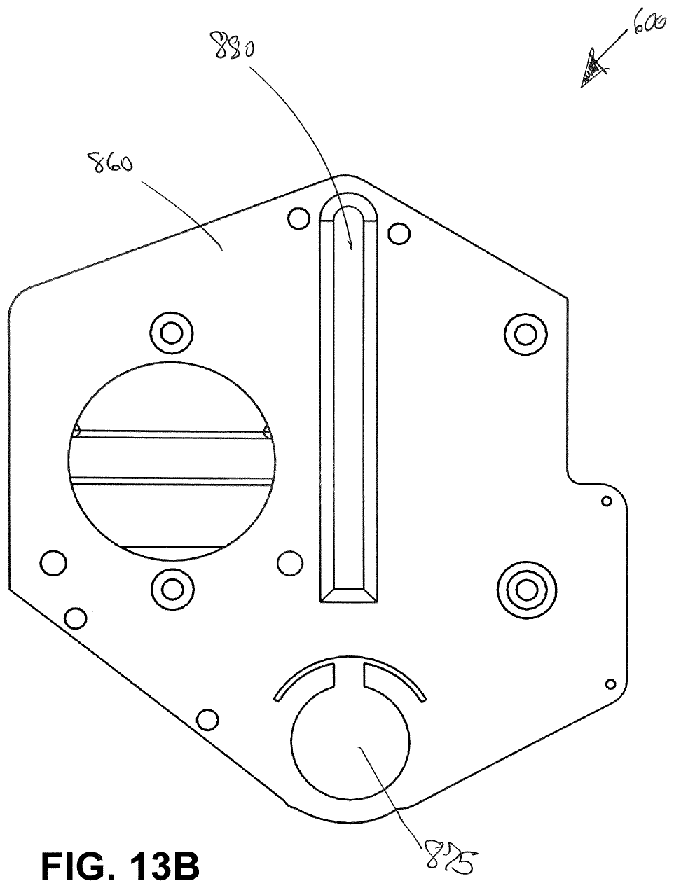

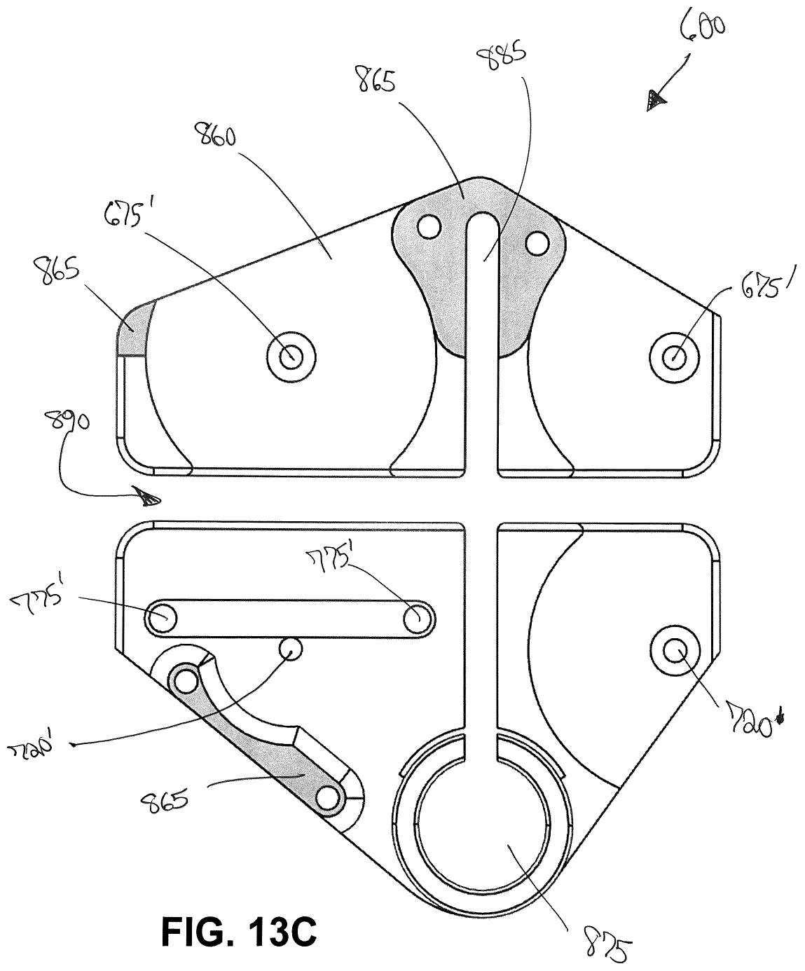

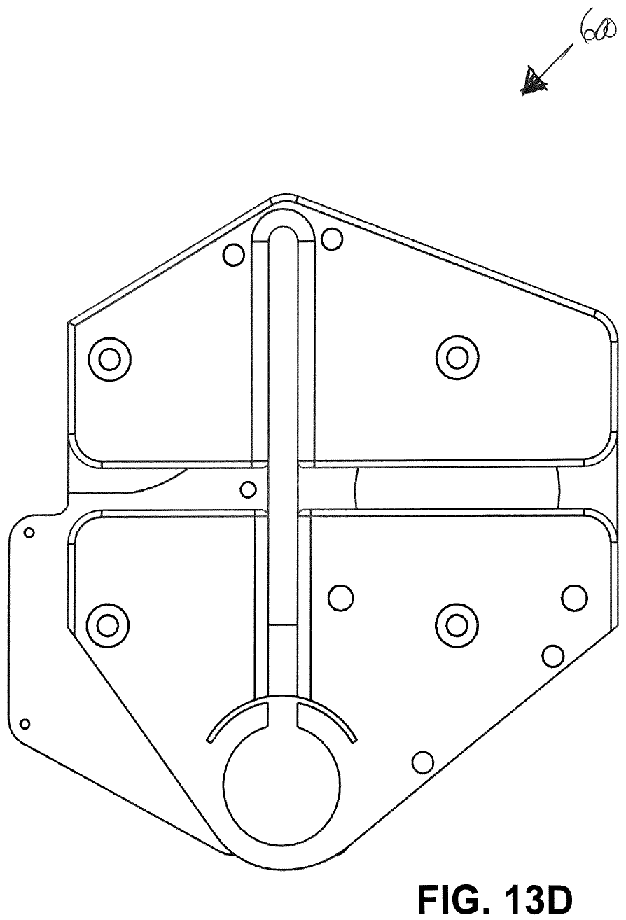

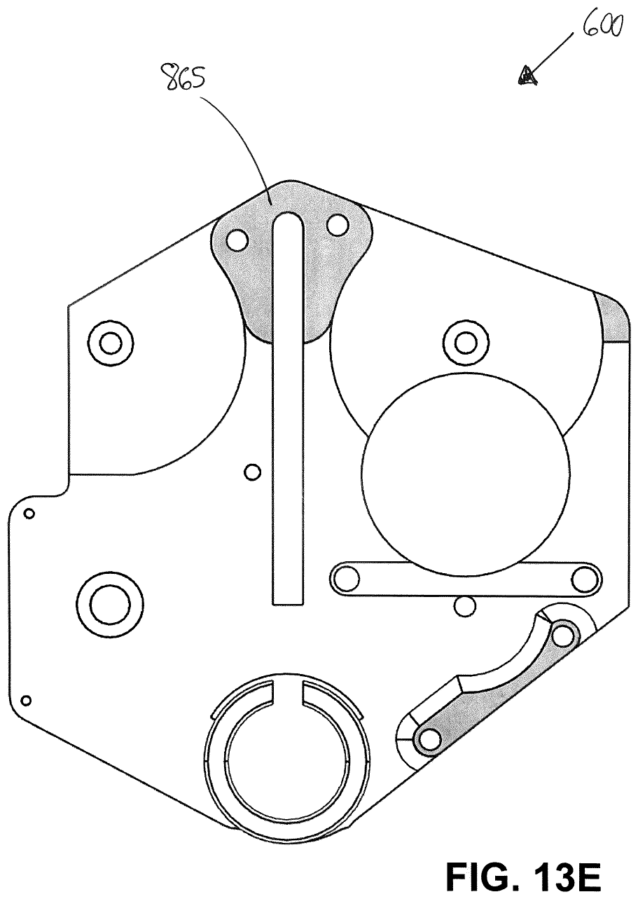

Referring to FIG. 13A, a perspective view of the trolley frame 600 is shown. The trolley frame 600 is, generally, a C-channel shaped structure. The trolley frame 600 has two plates 860 connected by a series of struts 865 such that the two plates 860 are spaced apart by the struts 865. A plurality of mounting holes extend through the trolley frame. Some of the mounting holes 870 extend through the struts 865 and are adapted to receive fasteners to attach the two plates 860 of the trolley frame 600 together via the struts 865. Some of the mounting holes 675′,720′ correspond with the internal passageway 675,720 of the wheels 640 and are configured to receive and attach the axles, about which the wheels 640 are able to rotate, to the trolley frame 600. Some of the mounting holes 775′ correspond with the mounting holes 775 extending through the sides of the braking bracket 745 and are adapted to receive fasteners to attach the braking assembly 635 to the trolley frame 600. Some of the mounting holes 870 correspond with mounting holes in the gear housing 630 and are configured to receive fasteners to attach the gear housing 630 and gears 625 to the trolley frame 600. Some of the mounting holes 875 correspond with the motor 620 and are configured to receive and attach the motor 620 to the trolley frame 600.

FIG. 13B is a front elevational view of the trolley frame of FIG. 13A. The front frame plate also has a vertical slot 880 extending therethrough. The vertical slot 880 is spaced apart from, and does not connect with, the mounting hole 875 in the front plate that is configured to receive and support the motor 620. The vertical slot 880 is, however, vertically aligned with the mounting hole 875 that receives the motor 620. The vertical slot 880 reduces the weight of the trolley 130, provides venting and improved air flow, and allows the spine bracket 605 to have reinforced structural sides that extend through the vertical slot 880.

FIG. 13C is a front elevational cross-sectional view of the trolley frame 600 of FIG. 13A. The front plate of the trolley frame 600 is cut away in FIG. 13C, revealing cross-sectional views of the struts 865 and a front elevational view of the interior surface of the rear frame plate. As shown, the rear frame plate also has corresponding mounting holes 675′,720′,775′,870 configured to receive axles and fasteners to attach or connect the struts 865, the wheels 640, the braking assembly 635, and the motor 620. As also shown, the rear frame plate has a vertical slot 885 that corresponds with the vertical slot 880 in the front frame plate, however, the vertical slot 885 in the rear frame plate is longer and connects with the mounting hole 875 for the motor 620. The vertical slot 885 in the rear frame plate is configured to receive the spine bracket 605 through the vertical slot 885 so that the spine bracket 605 can be attached to the trolley frame 600.

The rear frame plate also has a horizontal channel 890 (or “gap”) extending through the entire rear frame plate. The horizontal channel 890 is adapted to allow the rail brackets 405 to pass through the horizontal channel 890 as the trolley 130 rides along the rail portion 115. The struts 865 of the trolley frame 600 extend to the rear frame plate both above and below the horizontal channel 890. Thus, both portions of the rear frame plate are supported by the struts 865.

FIG. 13D is a rear elevational view of the trolley frame 600 of FIG. 13A.

FIG. 13E is a rear elevational cross-sectional view of the trolley frame 600 of FIG. 13A. The rear frame plate of the trolley frame 600 is cut away in FIG. 13E, revealing cross-sectional views of the struts 865 and a rear elevational view of the interior surface of the front frame plate.

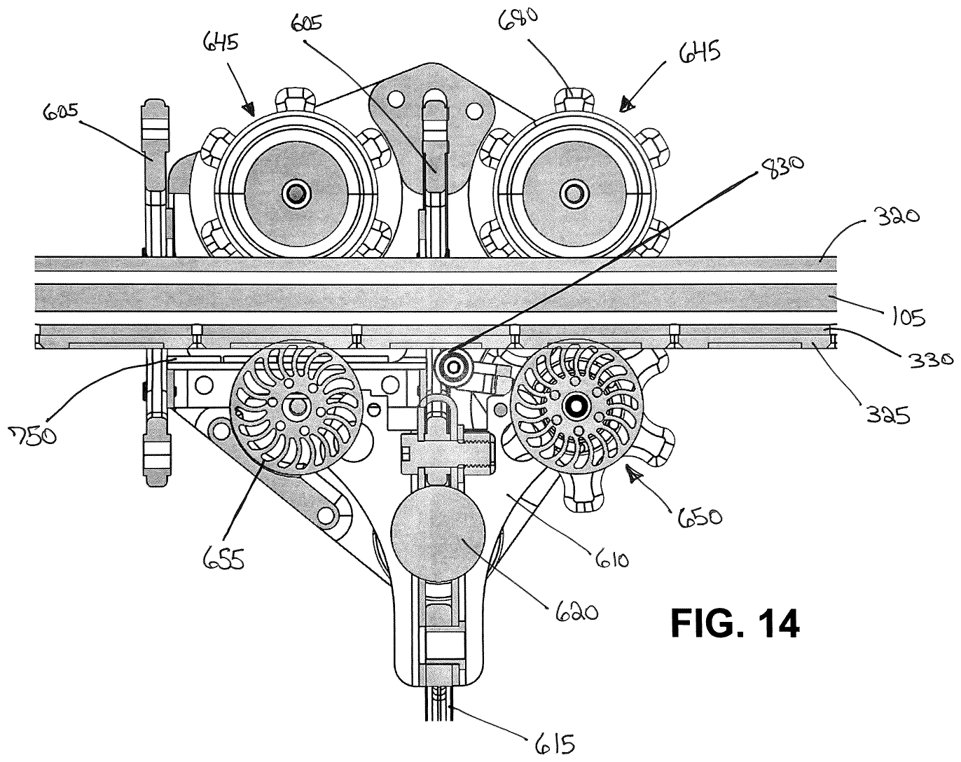

FIG. 14 is a front elevational cross-sectional view of the fully assembled trolley 130 riding on the alignment structure 145. The front frame plate, gear housing 630 and gears 625, and a portion of the braking assembly 635 are cut away in FIG. 14, revealing how the various elements of the trolley 130 interact with each other and with the alignment structure 145.

As shown, the two cable-to-rail wheel assemblies 645 are mounted toward the top of trolley frame 600 so that the cable-to-rail wheels 660 can contact and ride on top of the cable 105, the alignment rail 320 (pictured), and the rail 400. The axes of rotation of the cable-to-rail wheel assemblies 645 lie on the same horizontal plane, such that the cable-to-rail wheel assemblies 645 are aligned horizontally and enable the trolley 130 to sit flat on the cable 105 or rail 320,400.

As also shown, the crush wheel 655 and the crush wheel assembly 650 are mounted toward the bottom of the trolley frame 600 so that the crush wheels 655 contact the flat bottom surface of the conductor plate 325 and help keep the trolley aligned as it rides along the alignment structure 145 and the rail portion 115. The axes of rotation of the crush wheel 655 and the crush wheel 655 assembly 650 lie on the same horizontal plane such that the crush wheel 655 and crush wheel 655 assembly 650 are aligned horizontally.

As also shown, the spring 835 of the conductor assembly 785 biases the conductor bearings 830 to contact and remain in contact with the conductor plate 325. As will be described in more detail below, the conductor plate 325 carries an electric current. The contact between the conductor bearings 830 and the conductor plate 325 is what provides an electric current to the trolley 130, and more specifically, to the motor 620 and braking assembly 635. In one or more embodiments, instead of the conductor assembly 785, the electrical contact may be made via an electrical brush contact.

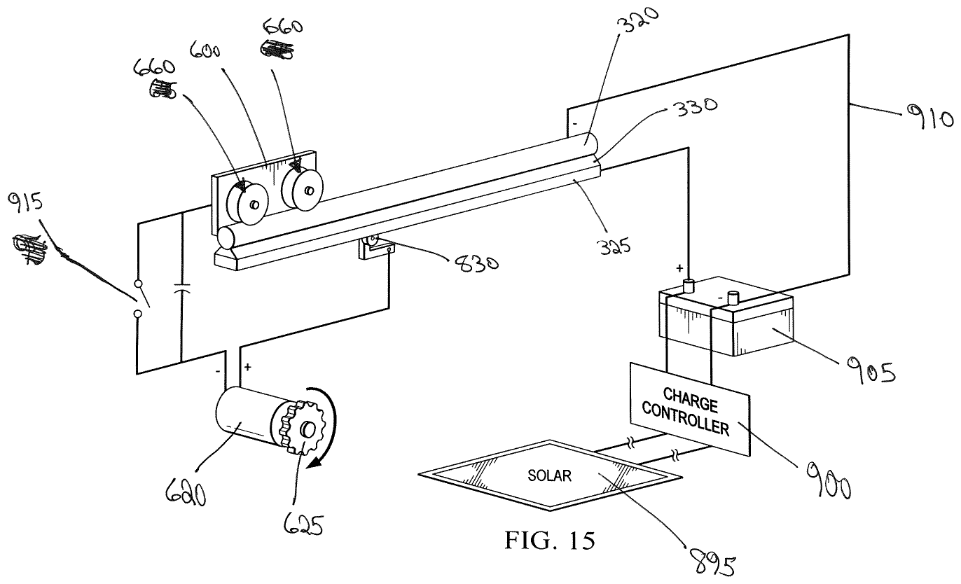

Referring to FIG. 15, a diagram showing how an electric circuit in the cable-to-rail system 100 is completed. In one or more embodiments, a plurality of solar panels 895 are used to provide power to the system. In other embodiments, power is supplied from an electrical grid and is converted from alternating current (“AC”) to direct current (“DC”). The power is supplied to a charge controller 900 and a DC battery system 905 which are used to control the power distribution in the cable-to-rail system 100. Power is supplied from the DC battery system 905 to the conductor plate 325 using insulated wire 910 that can be wired through the structural components of the cable-to-rail system 100 as necessary. The physical contact between the conductor bearings 830 and the conductor plate 325 supplies power to the trolley 130, including the motor 620 and the braking assembly 635. The trolley 130 is grounded via the cable-to-rail wheels 660. The cable-to-rail wheels 660 make physical contact with the alignment rail 320 and the rail 400. The alignment rail 320 and the rail 400 are connected to ground. In one or more embodiments, the trolley frame 600 is aluminum and the cable-to-rail wheels 660 are stainless steel with conductive bearings. In some embodiments, the alignment rail 320 and the rail 400 are wired back to the negative terminal of the DC battery system to ground the cable-to-rail system 100 and complete the electric circuit. As discussed above, the alignment rail 320 and the rail are electrically insulated from the conductor plate 325 via the insulator 330 disposed between them.

In one or more embodiments, the electric circuit includes an alternative switch 915 adapted to complete and break the electric circuit with respect to the motor 620. This alternative switch 915 can be used to supply power the motor 620 in order to propel the trolley 130 when automated propulsion is needed or desired. In one or more embodiments, the alternative switch 915 can be triggered manually by the rider or by an operator. In one or more embodiments, the alternative switch 915 can be triggered by a proximity sensor that detects the proximity of the trolley 130 with respect to another element or location within the cable-to-rail system 100. In one or more embodiments, the alternative switch 915 can be triggered by radio control, by infrared sensor or light sensor via a reflector, and/or by a microcontroller using radio frequency identification (“RFID”), global positioning system (“GPS”), and/or local positioning system.

With continuing reference to FIGS. 1-15, and to FIGS. 1, 4B, and 5A in particular, the operation of the cable-to-rail system 100 will be described in more detail.

The trolley 130 rides along the cable 105. The two cable-to-rail wheel assemblies 645 ride on top of the cable 105 via the first profiles 700 of the cable-to-rail wheels 660. When the path of the trolley 130 needs to turn or corner such that a rail 400 is better suited to carry the trolley 130 through the turn or corner, the trolley 130 is transitioned to the rail portion 115.

As the trolley 130 rides along the cable 105, it first contacts the entry structure 135 of the transition portion 110. The entry structure 135 lifts the trolley 130 up off the cable 105. After passing the entry structure 135, the trolley 130 rides along the transition structure 140 of the transition portion 110. The ramped structure of the transition tube 205 allows the cable-to-rail wheels 660 to smoothly transition from making contact with the cable 105 via the first profile 700 that is contoured to cooperate with the cable 105, to making contact with the with the transition tube 205 via the second profile 705 that is contoured to cooperate with the structure of the rails 320,400. The crush wheels 655 on the bottom of the trolley 130 start to make contact with the flat bottom surface of the transition plate 210 to facilitate alignment of the trolley 130 and to absorb energy from the impact with the transition portion 110, which provides some braking effect as well as making the transition smoother.

After riding along the transition portion 110, the trolley 130 transitions to the alignment structure 145. The second profiles 705 of the cable-to-rail wheels 660 contact and ride along the alignment rail 320. The conductor bearings 830 establish contact with the conductor plate 325 and the trolley 130 receives power through the electric circuit. Power is then supplied to the electromagnets 750 in the braking assembly 635, which induces eddy current braking as the conductor plate 325 passes through the braking assembly 635 directly between the electromagnets 750. If the magnets 750 in the braking assembly 635 are, on the other hand, permanent rare earth magnets 750, then power would not need to be supplied to the braking assembly 635. The eddy current braking imparts a contactless braking force on the trolley 130 that is proportional to the speed at which the trolley 130 is traveling. The resultant drag/braking force created by the eddy current braking system can also be modified as described above.

As the trolley 130 approaches the second end 350 of the alignment rail 320, the magnets 395 in the magnet bracket 385 attached to the side of the alignment rail 320 act upon the magnetic cog teeth 680 of the cog wheels 665. The magnetic forces acting on the cog teeth 680 facilitate alignment of the cog teeth 680 and the cog wheels 665 before the trolley reaches the rail portion 115. The length of the magnet bracket 385 can be optimized for the desired application. In some embodiments, the magnet bracket 385 can be longer and contain more magnets 395 if a greater distance is needed to pre-align the cog wheels 665, which may be dependent, for example on the speed of the trolley 130 or the curvature of the rail portion 115.

Once the trolley 130 transitions to the rail portion 115, the pre-aligned cog wheels 665 smoothly engage with the cog holes 440 in the rail brackets 405. The tension adjustment rail 410 includes additional magnets 515 extending along at least a portion of the tension adjustment rail 410 that are aligned with the cog holes 440 and also facilitate alignment of the cog wheels 665 to ensure a smooth transition.

One benefit of the engagement of the cog wheels 665 with the cog holes 440 as the trolley 130 rides along the rail portion 115 is that it enables the horizontal channel 890 in the trolley frame 600 to be wider, which reduces the incidence of the frame 600 contacting the rail brackets 405 and increases the tolerance for the alignment, or lack thereof, of the trolley frame 600 before it engages the rail brackets 405. The engagement of the cog wheels 665 with the cog holes 440 provides this benefit because the size of the cog wheel 665 and cog teeth 680 is configured such that at least one cog tooth 680 on each cog wheel 665 extends within the horizontal channel 890 as they rotate, and thus effectively block the horizontal channel 890. By blocking the horizontal channel 890 in the trolley frame 600, the cog teeth 680 prevent the trolley frame 600 from dislodging from and falling off of the rails 320,400.

The cog teeth 680 also have this effect as the trolley 130 rides along the cable 105 before encountering the cog holes 440 because the cog teeth 680, in some embodiments, rotate with the cable-to-rail wheels 660 and the crush wheels 655. As the trolley 130 rides along the cable 105, the cog teeth 680 block the horizontal channel 890 in the trolley frame 600 and prevent the cable 105 from escaping out from within the trolley frame 600 through the horizontal channel 890.

As discussed above, the insulator 330 and the conductor plate 325 continue along the bottom of the rail 400 throughout the rail portion 115. Thus, the conductor bearing 830 is able to make contact with the conductor plate 325 and complete the electric circuit while the trolley 130 rides along the rail portion 115.

With the electric circuit complete, power is supplied to the motor 620 while the trolley 130 rides along the rail portion 115, as long as the alternative switch 915 is closed if equipped. The motor 620 is operably connected to the gears 625 contained within the gear housing 630 of the trolley 130. The gears 625 are operably coupled to at least one of the cable-to-rail wheel assemblies 645 and/or the crush wheel assembly 650. When power is supplied to the motor 620, the motor 620 drives the gears 625, and the gears 625 drive the at least one wheel 645,650, each of which includes one of the cog wheels 665. With the cog wheels 665 engaged with the cog holes 440 in the rail brackets 405, the driven cog wheel(s) 665 is able to propel the trolley 130 forward.

This automated propulsion of the trolley 130 via the cog holes 440, cog wheels 665, gears 625, and motor 620 improves control over the speed of the trolley 130 and enables the trolley 130 to not be entirely reliant on gravitational forces to propel the trolley 130. If the trolley 130 were to get stuck or lose speed while on the rail 400, for example, the motor 620 would be able to kick in and propel the trolley 130.

In one or more embodiments, the alternative switch 915 is configured to reverse the polarity of the motor 620 to provide a modulated braking effect to slow the trolley 130 to a predetermined desired speed.

As discussed above, it may be desirable to transition the trolley 130 back to the cable 105. The transition portion 110 and tension adjustment rail 410 can be mirrored at the opposite end of the rail portion 115 to enable the trolley 130 to transition back to the cable 105.

In one or more embodiments, the cog wheels 665 may be omitted from the cable-to-rail system 100 and the motor 620 and gears 625 may drive the cable-to-rail wheel 660 and/or the crush wheel 655 and propel the trolley 105 using the frictional forces between the wheels 655,660 and the cable 105 or rail 320,400.

In one or more embodiments, the cog wheels 665, motor 620, and gears 625 may all be omitted if desired for the particular application.

The present disclosure introduces a system, the system including: a rail assembly via which a cable is tensioned to an anchor point, the rail assembly comprising a rail; and a trolley, comprising: one or more carriage wheels adapted to roll along the rail of the rail assembly; wherein the trolley further comprises: (a) a motor adapted to receive electricity from a power source to propel the trolley along the rail assembly; and a drive wheel having teeth; wherein the motor is further adapted to propel the trolley by rotating the drive wheel to engage the teeth with the rail assembly; and/or (b) a first electrical conductor adapted to contact a second electrical conductor as the one or more carriage wheels roll along the rail, the second electrical conductor being electrically coupled to a power source; wherein the rail assembly further comprises the second electrical conductor extending along at least a portion of the rail. In one embodiment, the trolley comprises (b); and the motor is adapted to receive electricity from the power source via the first and second electrical conductors. In one embodiment, the rail assembly further comprises an electrical insulator extending between the first electrical conductor and the rail to electrically insulate the rail from the first electrical conductor. In one embodiment, the trolley further comprises: a motor adapted to receive electricity from the power source via the first and second electrical conductors. In one embodiment, the trolley further comprises a drive wheel; and the motor is further adapted to propel the trolley by rotating the drive wheel to engage the rail assembly. In one embodiment, the trolley comprises (a) and (b); and the motor is adapted to receive the electricity from the power source via the first and second electrical conductors. In one embodiment, the system further includes the cable; wherein the one or more carriage wheels are further adapted to roll along the cable, and to transition between rolling along the cable and rolling along the rail. In one embodiment, the trolley further comprises: a braking assembly adapted to slow the one or more carriage wheels rolling along the rail by receiving at least a portion of the rail assembly between opposing magnets. In one embodiment, the rail assembly further comprises: an alignment surface; and a rail bracket operably coupled to, and extending from, the rail; and the trolley further comprises: a frame to which the one or more carriage wheels are rotatably coupled; and one or more alignment wheels adapted to roll along the alignment surface of the rail assembly to align a gap in the frame with the rail bracket.

The present disclosure also introduces an apparatus for a rail assembly, via which rail assembly a cable is tensioned to an anchor point, the apparatus including: one or more carriage wheels adapted to roll along a rail of the rail assembly; a motor adapted to receive electricity from a power source to propel the apparatus along the rail assembly; and a drive wheel having teeth; wherein the motor is further adapted to propel the apparatus by rotating the drive wheel to engage the teeth with the rail assembly. In one embodiment, the apparatus further includes a first electrical conductor adapted to contact a second electrical conductor of the rail assembly as the one or more carriage wheels roll along the rail, the second electrical conductor being electrically coupled to a power source; wherein the motor is adapted to receive the electricity from the power source via the first and second electrical conductors. In one embodiment, the one or more carriage wheels are further adapted to roll along the cable, and to transition between rolling along the cable and rolling along the rail. In one embodiment, the apparatus further includes a braking assembly adapted to slow the one or more carriage wheels rolling along the rail by receiving at least a portion of the rail assembly between opposing magnets. In one embodiment, the apparatus further includes a frame to which the one or more carriage wheels are rotatably coupled; and one or more alignment wheels adapted to roll along an alignment surface of the rail assembly to align a gap in the frame with a rail bracket operably coupled to, and extending from, the rail.

The present disclosure also introduces another apparatus for a rail assembly, via which rail assembly a cable is tensioned to an anchor point, the another apparatus including: one or more carriage wheels adapted to roll along a rail of the rail assembly; and a first electrical conductor adapted to contact a second electrical conductor of the rail assembly as the one or more carriage wheels roll along the rail, the second electrical conductor being electrically coupled to a power source. In one embodiment, the another apparatus further includes a motor adapted to receive electricity from the power source via the first and second electrical conductors. In one embodiment, the another apparatus further includes a drive wheel; wherein the motor is further adapted to propel the another apparatus by rotating the drive wheel to engage the rail assembly. In one embodiment, the one or more carriage wheels are further adapted to roll along the cable, and to transition between rolling along the cable and rolling along the rail. In one embodiment, the another apparatus further includes a braking assembly adapted to slow the one or more carriage wheels rolling along the rail by receiving at least a portion of the rail assembly between opposing magnets. In one embodiment, the another apparatus further includes a frame to which the one or more carriage wheels are rotatably coupled; and one or more alignment wheels adapted to roll along an alignment surface of the rail assembly to align a gap in the frame with a rail bracket operably coupled to, and extending from, the rail.

In several embodiments, the elements and teachings of the various embodiments may be combined in whole or in part in some (or all) of the embodiments. In addition, one or more of the elements and teachings of the various embodiments may be omitted, at least in part, and/or combined, at least in part, with one or more of the other elements and teachings of the various embodiments.

It is understood that variations may be made in the foregoing without departing from the scope of the present disclosure.

In several embodiments, the elements and teachings of the various embodiments may be combined in whole or in part in some (or all) of the embodiments. In addition, one or more of the elements and teachings of the various embodiments may be omitted, at least in part, and/or combined, at least in part, with one or more of the other elements and teachings of the various embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several embodiments, while different steps, processes, and procedures are described as appearing as distinct acts, one or more of the steps, one or more of the processes, and/or one or more of the procedures may also be performed in different orders, simultaneously and/or sequentially. In several embodiments, the steps, processes, and/or procedures may be merged into one or more steps, processes and/or procedures.

In several embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several embodiments have been described in detail above, the embodiments described are illustrative only and are not limiting, and those skilled in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A system, comprising:
a rail assembly via which a cable is tensioned to an anchor point, the rail assembly comprising a rail; and
a trolley, comprising:
one or more carriage wheels adapted to roll along the rail of the rail assembly;
wherein the trolley further comprises:
(a) a motor adapted to receive electricity from a power source to propel the trolley along the rail assembly; and
a drive wheel having teeth;
wherein the motor is further adapted to propel the trolley by rotating the drive wheel to engage the teeth with the rail assembly;
and
(b) a first electrical conductor adapted to contact a second electrical conductor as the one or more carriage wheels roll along the rail, the second electrical conductor being electrically coupled to the power source;
wherein the rail assembly further comprises the second electrical conductor extending along at least a portion of the rail.

2. The system of claim 1,
wherein the motor is adapted to receive electricity from the power source via the first and second electrical conductors.

3. The system of claim 2, wherein the rail assembly further comprises an electrical insulator extending between the first electrical conductor and the rail to electrically insulate the rail from the first electrical conductor.

4. The system of claim 1, further comprising the cable.

5. The system of claim 4, wherein the one or more carriage wheels are further adapted to roll along the cable, and to transition between rolling along the cable and rolling along the rail.

6. The system of claim 1, wherein the trolley further comprises:
a braking assembly adapted to slow the one or more carriage wheels rolling along the rail by receiving at least a portion of the rail assembly between opposing magnets.

7. The system of claim 1, wherein the rail assembly further comprises:
an alignment surface; and
a rail bracket operably coupled to, and extending from, the rail.

8. The system of claim 7, wherein the trolley further comprises:
a frame to which the one or more carriage wheels are rotatably coupled; and
one or more alignment wheels adapted to roll along the alignment surface of the rail assembly to align a gap in the frame with the rail bracket.

9. An apparatus for a rail assembly, via which rail assembly a cable is tensioned to an anchor point, the apparatus comprising:
one or more carriage wheels adapted to roll along a rail of the rail assembly;
a motor adapted to receive electricity from a power source to propel the apparatus along the rail assembly;
and
a drive wheel having teeth;
wherein the motor is further adapted to propel the apparatus by rotating the drive wheel to engage the teeth with the rail assembly.

10. The apparatus of claim 9, further comprising:
a first electrical conductor adapted to contact a second electrical conductor of the rail assembly as the one or more carriage wheels roll along the rail, the second electrical conductor being electrically coupled to a power source.

11. The apparatus of claim 10, wherein the motor is adapted to receive the electricity from the power source via the first and second electrical conductors.

12. The apparatus of claim 9, wherein the one or more carriage wheels are further adapted to roll along the cable, and to transition between rolling along the cable and rolling along the rail.

13. The apparatus of claim 9, further comprising:
a braking assembly adapted to slow the one or more carriage wheels rolling along the rail by receiving at least a portion of the rail assembly between opposing magnets.

14. The apparatus of claim 9, further comprising:
a frame to which the one or more carriage wheels are rotatably coupled; and
one or more alignment wheels adapted to roll along an alignment surface of the rail assembly to align a gap in the frame with a rail bracket operably coupled to, and extending from, the rail.

15. An apparatus for a rail assembly, via which rail assembly a cable is tensioned to an anchor point, the apparatus comprising:
one or more carriage wheels adapted to roll along a rail of the rail assembly; and
a first electrical conductor adapted to contact a second electrical conductor of the rail assembly as the one or more carriage wheels roll along the rail, the second electrical conductor being electrically coupled to a power source.

16. The apparatus of claim 15, further comprising:
a motor adapted to receive electricity from the power source via the first and second electrical conductors.

17. The apparatus of claim 16, further comprising:
a drive wheel;
wherein the motor is further adapted to propel the apparatus by rotating the drive wheel to engage the rail assembly.

18. The apparatus of claim 15, wherein the one or more carriage wheels are further adapted to roll along the cable, and to transition between rolling along the cable and rolling along the rail.

19. The apparatus of claim 15, further comprising:
a braking assembly adapted to slow the one or more carriage wheels rolling along the rail by receiving at least a portion of the rail assembly between opposing magnets.

20. The apparatus of claim 15, further comprising:
a frame to which the one or more carriage wheels are rotatably coupled; and
one or more alignment wheels adapted to roll along an alignment surface of the rail assembly to align a gap in the frame with a rail bracket operably coupled to, and extending from, the rail.
